(19) United States
(12) Patent Application Publication
(10) Pub. No.: US 2022/0225615 A1
(43) Pub. Date: Jul. 21, 2022

(54) COMPOSITIONS FOR CROP PROTECTION

(71) Applicant: Agrematch Ltd., Rehovot (IL)

(72) Inventors: Eitan GLICK, Ness Ziona (IL); Ifat SHUB, RaAnana (IL); Yael PHILLIP, Ness Ziona (IL); Yosef GEVA, Hatzor Ashdod (IL)

(73) Assignee: Agrematch Ltd., Rehovot (IL)

(21) Appl. No.: 17/610,470

(22) PCT Filed: May 13, 2020
(86) PCT No.: PCT/IL2020/050522

§ 371 Date: Nov. 11, 2021

Related U.S. Application Data
(60) Provisional application No. 62/846,826, filed on May 13, 2019.
(60) Provisional application No. 62/846,761, filed on May 13, 2019.

(51) Int. Cl. A01N 43/78; A01P 13/00

(52) U.S. Cl. CPC A01N 43/78; A01P 13/00

(57) ABSTRACT

The present invention provides herbicidal compositions and use thereof as for controlling plant growth.

### CROSS-REFERENCE TO RELATED APPLICATIONS

This application claims the benefit of priority of U.S. Provisional Patent Application No. 62/846,761 and U.S. Provisional Patent Application No. 62/846,826, both filed May 13, 2019 and titled “COMPOSITIONS FOR CROP PROTECTION”, the contents of which are incorporated herein by reference in their entirety.

### FIELD OF INVENTION

The present invention relates to herbicidal compositions.

### BACKGROUND OF THE INVENTION

The protection of crops from undesirable vegetation, which inhibits crop growth, is a constantly recurring problem in agriculture. Many different herbicides have been used over the years to control and kill such weeds. However, problems have more recently been experienced with the use of many of these herbicides, as the weeds have developed a significant resistance against them over time. In some locations the conventional herbicides are therefore no longer sufficiently effective. There is, therefore, an ongoing demand for development of new herbicides.

### SUMMARY OF THE INVENTION

In one aspect of the invention, there is provided a herbicidal composition, comprising a compound represented by Formula I:

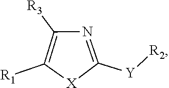

wherein: X is selected from N, S, and O; R₁ and Y are independently selected from the group consisting of: a nitro group, a hydroxy group, a carboxylic acid derivative, a halo group, a cyano group, a sulfinyl group, a sulfone group, a sulfonate group, a keto group, formyl, a haloalkyl group, —N(C₁-C₅), an azo group, O, P, N, NH, S, C, an optionally substituted C₄-C₂₀ cycloalkyl group, an optionally substituted C₅-C₂₀ heterocyclyl group, an optionally substituted aryl group, and a heteroaryl group or any combination thereof; R₂ represents a substituent independently selected from the group consisting of: hydrogen, an alkylhydroxy group, an alkoxy group, a thioalkoxy group, a thioalkyl group, an optionally substituted C₄-C₂₀ alkyl group, an optionally substituted C₄-C₂₀ cycloalkyl group, an optionally substituted C₄-C₂₀ bicyclic ring, an optionally substituted C₄-C₂₀ heterocyclyl group, an optionally substituted aryl group, an

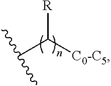

optionally substituted heteroaryl, and or any combination thereof, or R₂ is absent; each R is independently selected from the group consisting of: an optionally substituted C₄-C₂₀ heterocyclyl, an optionally substituted C₄-C₂₀ cycloalkyl group, a mercapto group, an amino, a hydroxy group, a halo group, a cyano group, a nitro group, a carboxylic acid derivative, and an optionally substituted C₁-C₁₀ alkyl group comprising a heteroatom or any combination thereof; each n is independently 1 to 3; R₃ is selected from the group consisting of: an alkyl group, an alkylhydroxy group, an alkoxy group, a halo group, a haloalkyl group, a nitro group, a hydroxy group, a sulfinyl group, a sulfone group, and a sulfonate group or any combination thereof, or R₃ is absent; and if Y comprises a nitro group, a hydroxy group, a halo group, or a cyano group then R₂ is absent, wherein said herbicidal composition comprises said compound, an agriculturally acceptable salt of said compound or both.

In one embodiment, R₃ is selected from the group consisting of: a C₁-C₅ alkyl group, an alkylhydroxy group, an alkoxy group, a halo group, a haloalkyl group, a nitro group, a hydroxy group, a sulfinyl group, a sulfone group, and a sulfonate group or any combination thereof, or R₃ is absent.

In one embodiment, Y is NH, and R₂ is selected from the group consisting of: hydrogen, an optionally substituted C₄-C₈ alkyl group, an optionally substituted C₄-C₆ heterocyclyl group, an optionally substituted C₄-C₆ cycloalkyl group, a C₆-C₁₂ heterocyclyl, and

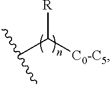

or any combination thereof.

In one embodiment, the compound is represented by Formula IV:

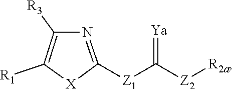

wherein: Yₐ is selected from O, N, and S; Z₁ is selected from O, NH, C, and S; Z₂ is selected from H, O, N, C, and S, or is absent; R₂ₐ is selected from the group consisting of: a C₁-C₅ haloalkyl group, a C₅-C₁₀ cycloalkyl group, a C₅-C₁₀ alkyl group, —(CH₂)ₚ-T-(CH₂)ₒ, C₀-C₅ alkaryl obyionally substituted by R₅, and

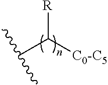

or any combination thereof, wherein: T is selected from O, S and N, p is 1 to 4, o is 1 to 5, and if T is O and p is 1 then o is selected from 1, 3, 4 and 5 and R₅ is selected from the group consisting of: hydrogen, a halo group, a C₁-C₅ alkyl group, an C₁-C₅ alkoxy group, a C₁-C₅ thioalkoxy group, a carboxylic acid derivative, a hydroxy group, a mercapto group, a sulfinyl group, a sulfone group, a sulfonate group, a cyano group, and an azo group.

In one embodiment, R₃ is selected from hydrogen, and a C₁-C₅ alkyl group.

In one embodiment, the compound is represented by Formula V:

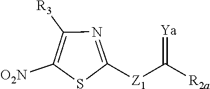

### or by Formula VI:

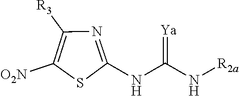

wherein: Z₁ is selected from O, and N; and Yₐ is selected from O, and S.

In one embodiment, the compound is represented by Formula III:

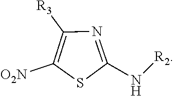

In one embodiment, R₁ is a nitro group, and Y is selected from the group consisting of: hydrogen, an optionally substituted C₃-C₉ heterocyclyl group, an optionally substituted C₅-C₉ heteroaryl group, and an optionally substituted C₅-C₉ aryl group or any combination thereof.

In one embodiment, substituted comprises a substituent independently selected from the group consisting of: a hydroxy group, an amino group, a cyano group, a halo group, and a mercapto group.

In one embodiment, the compound is selected from the group consisting of:

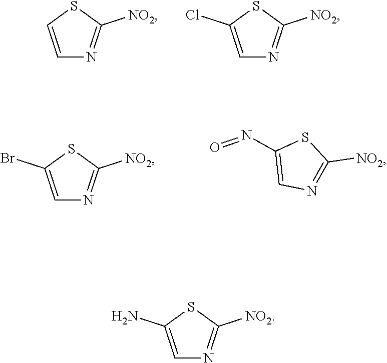 [SMILES: O=[N+]([O-])c1nccs1 ; O=[N+]([O-])c1ncc(Cl)s1 ; O=[N+]([O-])c1ncc(Br)s1 ; O=Nc1cnc([N+](=O)[O-])s1 ; Nc1cnc([N+](=O)[O-])s1]

In another aspect, there is a herbicidal composition, comprising a compound represented by Formula I:

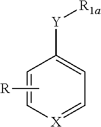

wherein: X is —N, or —CH; Y is selected from O, P, N, and S; R represents a substituent, independently comprising or being selected from the group consisting of: an alkyl group, an alkoxy group, carboxyethyl, carboxymethyl, a halo group, an amino group, a guanidine group, a thioalkoxy group, a hydroxy group, a mercapto group, a cyano group, a haloalkyl group, a nitro group, an azo group, a sulfonate group, a sulfinyl group, a vinyl group, an allyl group, a thioalkyl group, an alkylhydroxy group, carboxyethyl, carboxymethyl, and a sulfone group or any combination thereof; R₁ₐ represents a substituent, independently comprising or being selected from the group consisting of: an alkyl group, an alkylhydroxy group, (C₁-C₅ alkyl)-R₂-(C₁-C₅ alkyl)₀₋₂, an alkoxy group, an amino group, a guanidine group, a thioalkoxy group, a thioalkyl group, a hydroxy group, a mercapto group, an allyl group, a vinyl group, a cyano group, a nitro group, an alkylamino group, an alkylamide group, a halo group, a haloalkyl group, an azo group and a carboxylic acid derivative or any combination thereof; and R₂ is selected from the group consisting of: and R₂ is selected from the group consisting of: an ester group, an amide, a carbamide, a carbamate, a thioester, a carbonate ester, N, S, O, P, phosphonate, phosphate, thiophosphate, —S(O)—, —S(O)₂—, —OS(O)₂—, —S(O)₂N- and

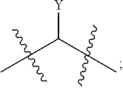

and and wherein said herbicidal composition comprises said compound, an agriculturally acceptable salt of said compound or both.

In one embodiment, each R is independently selected from the group consisting of: an alkyl group, a halo group, an alkylhydroxy group, carboxyethyl, carboxymethyl, a an alkoxy group, an amino group, a guanidine group, a thioalkoxy group, a thioalkyl group, a hydroxy group, a mercapto group, a vinyl group, an allyl group, a cyano group, a haloalkyl group, a nitro group, and an azo group or any combination thereof.

In one embodiment, R₂ is selected from the group consisting of: —C(O)NH—, —C(O)N—, —NC(O)—, —C(N)—, N, S, O and

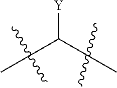

or any combination thereof.

In one embodiment, the compound is represented by Formula IIIb:

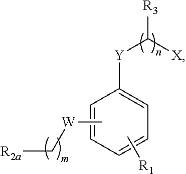

wherein: each R₃ is independently selected from the group consisting of: hydrogen, a linear C₁-C₄ alkyl group, a branched C₁-C₄ alkyl group, carboxyethyl, carboxymethyl, a substituted C₁-C₄ alkyl group, an alkylhydroxy group, a hydroxy group, a mercapto group, a halo group, a cyano group, an amino group, a nitro group, a sulfonate group, a sulfinyl group, and a sulfone group, an alkoxy group, a thioalkoxy group, a phosphine group, and a carboxylic acid derivative or any combination thereof; X is selected from the group consisting of: a C₁-C₁₀ alkyl group, hydrogen, a carboxylic acid derivative, —N(R₃)₂, —SR₃, —OR₃, —P(R₃)₂, phosphonate, phosphate, thiophosphate, —S(O)R₃, —S(O)₂R₃, —OS(O)₂R₃, —S(O)₂N(R₃)₂, an alkylhydroxy group, (C₁-C₅ alkyl)-R₂-(C₁-C₅ alkyl)₀₋₂, an alkylamide group, an alkylamino group, a thioalkyl group, an allyl group, and a haloalkyl group or any combination thereof; R₁represents a substituent independently selected from the group consisting of: hydrogen, an alkyl group, an alkylhydroxy group, carboxyethyl, carboxymethyl, (C₁-C₅ alkyl)-R₂-(C₁-C₅ alkyl)₀₋₂, an alkoxy group, an amino group, a guanidine group, a thioalkoxy group, a thioalkyl group, a hydroxy group, a mercapto group, an allyl group, a vinyl group, a cyano group, a nitro group, an alkylamino group alkylamide group, a halo group, a haloalkyl group, an azo group and a carboxylic acid derivative or any combination thereof; each W independently comprises a heteroatom or a bond, and at least one W comprises a heteroatom; n is from 1 to 3 and m is from 0 to 5; and R₂ₐ comprises a C₁-C₄ alkyl or hydrogen.

In one embodiment, the compound is represented by Formula IIIc:

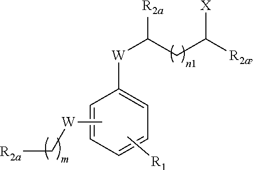

wherein n1 is from 0 to 3.

In one embodiment, X is any one of

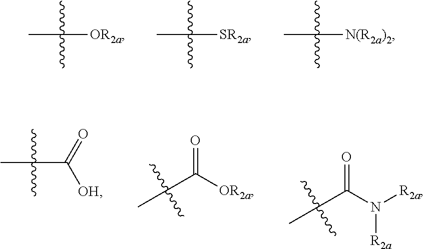

and if X is carboxy, then n1 is 0.

In one embodiment, the compound is represented by Formula IIIc:

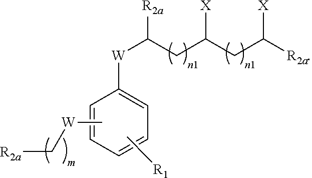

In one embodiment, substituted comprises one or more substituents independently selected from a hydroxy group, a halo group, a sulfonate group, a sulfinyl group, a sulfone group, a mercapto group, an amino group, an amide group, and an alkoxy group or any combination thereof.

In one embodiment, the compound is selected from the group consisting of:

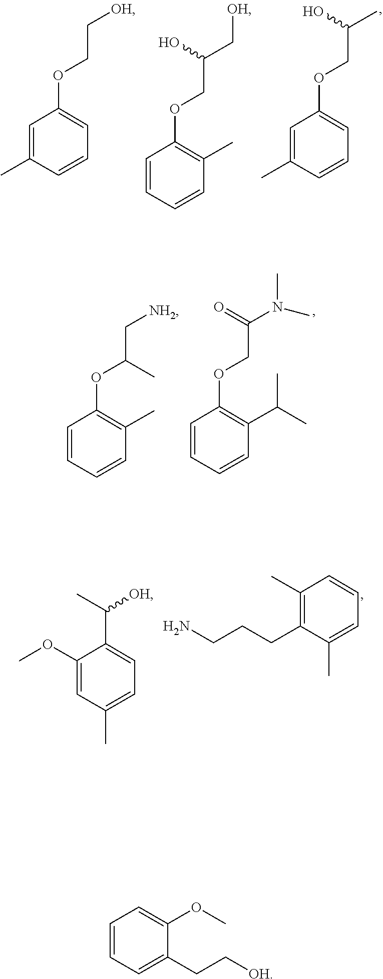

In one embodiment, the compound is selected from the group consisting of:

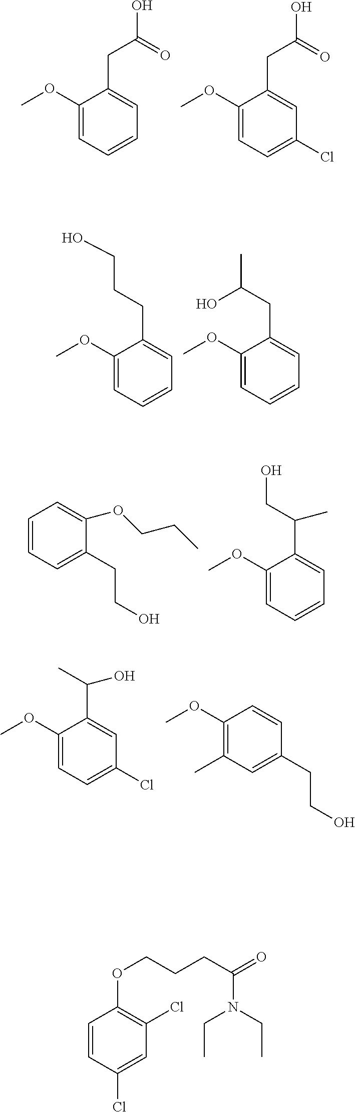

In one embodiment, the herbicidal composition further comprising an agriculturally acceptable carrier.

In another aspect, there is a method for controlling plant growth, comprising contacting the plant, a part of the plant, a seed of the plant, or the area under cultivation with the herbicidal composition of the invention.

In one embodiment, the plant is selected from a crop plant and a weed.

In one embodiment, the method is for controlling growth of said weed.

In one embodiment, contacting comprises applying an effective amount of the herbicidal composition to the plant, a part of the plant, a seed of the plant, or the area under cultivation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

The present invention is directed to a herbicidal composition comprising a compound of the invention and use thereof such as for herbicidal use. Compounds disclosed in the present invention comprise phenyl derivatives and thiazole derivatives.

The present invention is also directed to a method for preventing or reducing undesired plant growth, comprising contacting a composition described herein with the plant, or the area under cultivation.

Phenyl and thiazole derivatives disclosed by the present invention, were discovered by methods of computational screening using big-data analysis platforms. After several optimization cycles in silico, a chemical library of ca. 50 molecules was obtained for the phenyl derivatives and for the thiazole derivatives.

The disclosed compounds were selected based on results obtained from plant growth experiments, as exemplified by the Examples provided hereinbelow. Compounds, which exhibited a herbicidal effect (e.g. against Amaranthus palmeri) in in paper germination experiment (Example 1), inducing at least 70% inhibition of Amaranthus palrneri germination and/or at least 50% inhibition of Amaranthus palmeri germination in preemergence experiment (Example section), were selected as suitable herbicidal candidates.

The present invention is based, in part, on the finding that phenyl derivatives having at least two substituents exhibit a herbicidal effect (e.g. against Amaranthus palmeri) upon applying to a plant, or the area under cultivation. In contrary, it was found that phenyl derivatives having one substituent (e.g. carboxypropyl and/or 2-carboxy-2-oxy-ethyl) were substantially ineffective.

Furthermore, the present invention is based, in part, on the finding that thiazole derivatives (e.g. nitrothiazole- and aminothiazole-based compounds) exhibit a herbicidal effect (e.g. against Amaranthus palmeri) upon applying to a plant, or the area under cultivation. In contrary, nitro-substituted phenyl or carboxy-substituted thiazole were substantially ineffective.

Furthermore, some of the compounds of the invention didn't show a herbicidal effect against field crops of the genus Zea (e.g. Zea mays), and at the same time exhibited selective herbicidal activity against different weed species, as represented in the Example section.

Thus, the present invention provides a compound or a composition for use in controlling or preventing undesired plant growth.

### Phenyl Derivatives

According to an aspect of the present invention, there is provided a herbicidal composition comprising a compound represented by Formula I:

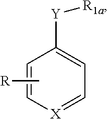

wherein:
X is —N, or —CH; Y is selected from O, P, N, and S; R represents a substituent, independently comprising or being selected from the group consisting of: an alkyl group, an alkylhydroxy group, an alkoxy group, an amino group, a guanidine group, a thioalkoxy group, a thioalkyl group, a hydroxy group, a mercapto group, a vinyl group, carboxyethyl, carboxymethyl, an allyl group, a cyano group, a haloalkyl group, a nitro group, an azo group, a sulfonate group, a sulfinyl group, a halo group, and a sulfone group; R₁ₐ represents a substituent, independently comprising or being selected from the group consisting of: an alkyl group, an alkylhydroxy group, an alkoxy group, (C₁-C₅ alkyl)-R₂-(C₁-C₅ alkyl)₀₋₂, an amino group, a guanidine group, a thioalkoxy group, a thioalkyl group, a hydroxy group, a mercapto group, an allyl group, a vinyl group, a cyano group, a nitro group, an alkylamino group, an alkylamide group, a halo group, a haloalkyl group, an azo group and a carboxylic acid derivative; and R₂ is selected from the group consisting of: an ester group, an amide, a carbamide, a carbamate, a thioester, a carbonate ester, N, S, O, P, phosphonate, phosphate, thiophosphate, —S(O)—, —S(O)₂-, —OS(O)₂—, —S(O)₂N- and

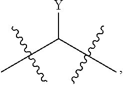

wherein Y is as described herein. In some embodiments, the compound comprises an aromatic ring substituted by at least two substituents (e.g. R and Y-R₁ₐ) which are not hydrogen, wherein at least two substituents are as described herein.

In some embodiments, the herbicidal composition further comprises a herbicidally active derivative of the compound. The term “herbicidally active derivative” refers to any derivative of the compound exhibiting a herbicidal activity, or to a derivative which undergoes a chemical transformation, e.g. in plants, water, or in soil, and thus becoming herbicidally active. An example of such derivative is an ester, which hydrolyses in plants or soil, thereby releasing an active compound of the invention.

In some embodiments, the herbicidal composition comprises the compound of the invention, an agriculturally acceptable salt thereof or both.

In some embodiments, the compound comprises a substituted phenyl ring. In some embodiments, the compound comprises a substituted pyridine ring. In some embodiments, the compound of the invention is substantially stable in an aqueous solution for at least one hour. In some embodiments, substantially is at least 70%, at least 80%, at least 85%, at least 90%, at least 92%, at least 95%, at least 97%, at least 98%, at least 99% by weight of the initial amount of the compound remains stable. In some embodiments, the term “stable” is referred to a chemical stability of the compound.

In some embodiments, the compound of Formula I comprises one to four substituents represented by R, as described hereinabove. In some embodiments, all the substituents are identical. In some embodiments, all the substituents are different. In some embodiments, some of the substituents are identical. In some embodiments, R is positioned at any one of the ortho, meta, and para positions. In some embodiments, R is positioned ortho relative to YR₁ₐ. In some embodiments, R is positioned meta relative to YR₁ₐ. In some embodiments, R is positioned para relative to YR₁ₐ if X is CH.

In some embodiments, each R is selected independently from the group consisting of: an alkyl group, a halo group, an alkylhydroxy group, carboxyethyl, carboxymethyl, an alkoxy group, an amino group, a guanidine group, a thioalkoxy group, a thioalkyl group, a hydroxy group, a mercapto group, a vinyl group, an allyl group, a cyano group, a haloalkyl group, a nitro group, an azo group, a sulfonate group, a sulfinyl group, and a sulfone group.

In some embodiments, each R is selected independently from the group consisting of: an alkyl group, an alkylhydroxy group, carboxyethyl, carboxymethyl, a halo group, an alkoxy group, an amino group, a guanidine group, a thioalkoxy group, a thioalkyl group, a hydroxy group, a mercapto group, a vinyl group, an allyl group, a cyano group, a haloalkyl group, a nitro group, and an azo group.

As used herein, the term “alkyl” or a derivative thereof (e.g. haloalkyl, alkylhydroxy, thioalkyl, alkylamide) refers to a C₁-C₁₀ alkyl or to a C₁-C₂₀ alkyl. In some embodiments, C₁-C₁₀ alkyl comprises C₁-C₅ alkyl, C₁-C₃ alkyl, C₁-C₄ alkyl, C₅-C₈ alkyl, C₅-C₇ alkyl, C₁-C₅ alkyl, C₁-C₂ alkyl, C₂-C₃ alkyl, C₃-C₄ alkyl, C₄-C₅ alkyl, C₅-C₆ alkyl, C₆-C₇ alkyl, C₇-C₈ alkyl, C₈-C₁₀ alkyl, including any range or value therebetween.

In some embodiments, C₁-C₂₀ alkyl comprises C₁-C₅ alkyl, C₁-C₃ alkyl, C₁-C₄ alkyl, C₅-C₈ alkyl, C₅-C₇ alkyl, C₁-C₅ alkyl, C₁-C₂ alkyl, C₂-C₃ alkyl, C₃-C₄ alkyl, C₄-C₅ alkyl, C₅-C₆ alkyl, C₆-C₇ alkyl, C₇-C₈ alkyl, C₈-C₁₀ alkyl, C₁-C₁₀ alkyl, C₅-C₂₀ alkyl, C₁₀-C₁₅ alkyl, C₁₀-C₁₂ alkyl, C₁₀-C₁₃ alkyl, C₁₅-C₂₀ alkyl, C₁₅-C₁₇ alkyl, C₁₇-C₂₀ alkyl, including any range or value therebetween.

As used herein, the term “cycloalkyl” refers to a C₃-C₂₀ cyclic ring (optionally comprising at least one unsaturated bond), a C₃-C₂₀ heterocyclic ring comprises at least one heteroatom (i.e. N, S, or O), a C₄-C₂₀ bicyclic ring, a C₄-C₂₀ fused ring, a C₄-C₂₀ bridged ring group. In some embodiments, cycloalkyl further comprises at least one substituent, wherein the substituent is as described herein.

In some embodiments, fused ring (e.g. fused aliphatic ring) comprises norbornane, bicyclooctane, bicyclodecane or a combination thereof. In some embodiments, at least one ring of the bicyclic ring comprises a heterocyclic aliphatic ring. In some embodiments, the heterocyclic aliphatic ring comprises oxirane, tetrahydrofuran, aziridine, pyrrolidine, piperidine, or morpholine.

As used herein, the term “4-20 ring” is referred to a cyclic aliphatic or aromatic compound comprising between 4 and 20 carbon atoms. In some embodiments, 4-20 ring bicyclic ring comprises between 4 and 6, between 5 and 8, between 5 and 7, between 8 and 9, between 9 and 10, between 10 and 12, between 12 and 15, between 6 and 12, between 15 and 20 carbon atoms including any value therebetween.

In some embodiments, C₄-C₂₀ ring or C₄-C₂₀ cycloalkyl comprises C₄-C₂₀ ring, C₄-C₆ ring, C₆-C₈ ring, C₈-C₁₀ ring, C₄-C₈ ring, C₁₀-C₁₂ ring, C₁₀-C₁₅ ring, C₁₅-C₂₀ ring, including any range or value therebetween. In some embodiments, (C₃-C₂₀) ring comprises optionally substituted cyclopropane, cyclobutene, cyclopentane, cyclohexane, or cycloheptane.

As used herein, the term “aryl” refers to a C₅-C₂₀ aromatic ring, a C₅-C₂₀ heteroaromatic ring comprises at least one heteroatom (i.e. N, S, or O), a C₈-C₂₀ bicyclic ring comprising at least one aromatic ring, a C₈-C₂₀ fused ring comprising at least one aromatic ring, a C₆-C₂₀ bridged ring comprising at least one aromatic ring. In some embodiments, aryl further comprises at least one substituent, wherein the substituent is as described herein.

In some embodiments, C₅-C₂₀ ring and/or C₆-C₂₀ ring comprises C₅-C₆ ring, C₅-C₇ ring, C₅-C₈ ring, C₈-C₁₀ ring, C₆-C₇ ring, C₆-C₈ ring, C₆-C₁₀ ring, C₁₀-C₁₃ ring, C₁₀-C₁₅ ring, C₁₅-C₂₀ ring, including any range or value therebetween.

In some embodiments, C₈-C₂₀ bicyclic aryl comprises C₈-C₁₀ ring, C₈-C₉ ring, C₁₀-C₁₂ ring, C₁₀-C₁₃ ring, C₁₀-C₁₅ ring, C₁₃-C₁₅ ring, C₁₅-C₂₀ ring, including any range or value therebetween.

Non-limiting examples of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazole, pyridine, pyrrole, oxazole, indole, purine and the like.

In some embodiments, Y is covalently bound to a substituent represented by R₁ₐ as described hereinabove. In some embodiments, Y is P or N covalently bound to one or two substituents represented by R₁ₐ.

In some embodiments, each R₁ₐ is selected independently from the group consisting of: an alkyl group, an alkylhydroxy group, an alkoxy group, an amino group, a guanidine group, a thioalkoxy group, a thioalkyl group, a hydroxy group, a mercapto group, an allyl group, a vinyl group, a cyano group, a nitro group, an alkylamino group an alkylamide group, carboxyethyl, carboxymethyl, a halo group, a haloalkyl group, an azo group and a carboxylic acid derivative.

In some embodiments, the compound is represented by Formula II:

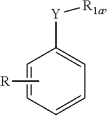

wherein:

Y is selected from O, and S; R₁ₐ is selected from the group consisting of: a C₁-C₁₀ alkyl group, an alkylhydroxy group, (C₁-C₅ alkyl)-R₂-(C₁-C₅ alkyl)₀₋₂, an alkylamide group, an alkylamino group, a thioalkyl group, an allyl group, and a haloalkyl group; and each R is independently selected from the group consisting of: a C₁-C₁₀ alkyl group, an alkylhydroxy group, carboxyethyl, carboxymethyl, an alkoxy group, an amino group, a guanidine group, a thioalkoxy group, a thioalkyl group, a hydroxy group, a mercapto group, a vinyl group, an allyl group, a cyano group, a haloalkyl group, a nitro group, and an azo group.

In some embodiments, the compound of Formula II comprises one to three substituents represented by R, as described hereinabove.

In some embodiments, the compound of Formula II comprises one or two substituents represented by R₁ₐ, and each R₁ₐ is independently selected from the group consisting of: a C₁-C₁₀ alkyl group, (C₁-C₅ alkyl)-R₂-(C₁-C₅ alkyl)₀₋₂, an alkylhydroxy group, an alkylamide group, carboxyethyl, carboxymethyl, an alkylamino group, and a thioalkyl group.

In some embodiments, the compound is represented by Formula III:

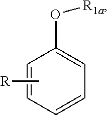

wherein R₁ₐ and R are as described hereinabove.

In some embodiments, each R is independently selected from the group consisting of: a C₁-C₆ alkyl group, an alkylhydroxy group, carboxyethyl, carboxymethyl, an alkoxy group, an amino group, a guanidine group, a thioalkoxy group, a thioalkyl group, a hydroxy group, a mercapto group, a vinyl group, an allyl group, a cyano group, and a haloalkyl group.

In some embodiments, each R is independently selected from the group consisting of: a C₁-C₆ alkyl group, an alkylhydroxy group, -(C₁-C₆ alkane)₀₋₁-C(O)-(C₁-C₆ alkane), an amino group, a guanidine group, a hydroxy group, a mercapto group, a vinyl group, an allyl group, and a cyano group.

In some embodiments, each R is independently selected from the group consisting of a linear C₁-C₆ alkane group, a branched C₁-C₆ alkane group, a substituted C₁-C₆ alkane group, a C₁-C₆ alkylhydroxy group, —C(O)-(C₁-C₆ alkane), a hydroxy group, and an allyl group.

In some embodiments, R₁ₐ is selected from the group consisting of: a linear C₁-C₆ alkyl group, a branched C₁-C₆ alkyl group, a substituted C₁-C₆ alkyl group, (C₁-C₃ alkyl)-R₂-(C₁-C₃ alkyl)₀₋₂, an alkylhydroxy group, an alkylamide group, an alkylamino group.

In some embodiments, R₁ₐ is (C₁-C₃ alkyl)-R₂-(C₁-C₃ alkyl)₁₋₂, wherein R₂ is selected from the group consisting of: —C(O)NH—, —C(O)N—, —NC(O)—, —C(N)—, —C(O)O—, —OC(O)-, N, S, and O. In some embodiments, R₁ₐ is (C₁-C₂ alkyl)-R₂-(C₁-C₃ alkyl)₀₋₂, wherein R₂ is selected from the group consisting of: —C(O)NH—, —C(O)N—, —NC(O)—, —C(N)—, —C(O)O—, —OC(O)-, N, S, and O.

In some embodiments, R₁ₐ is selected from: a linear C₁-C₄ alkane group, a branched C₁-C₄ alkane group, a linear C₁-C₄ alkene group, a linear C₁-C₄ alkylamino group, and a linear C₁-C₄ alkylamide group.

In some embodiments, R₁ₐ optionally comprises one to three substituents.

Non-limiting examples of substituents include, but are not limited to: a hydroxy group, an amino group, a halo group, an alkoxy group, a nitro group, a cyano group, an alkyl group, an amide group, a phosphine group, a thioalkoxy group, a mercapto group, a sulfinyl group, and a sulfone group or any combination thereof.

In some embodiments, R₁ₐ optionally comprises one to three substituents independently selected from: a hydroxy group, a mercapto group, an amino group, an amide group, and an alkoxy group or any combination thereof.

In some embodiments, the compound is represented by Formula IIIa:

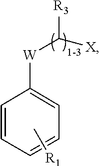

wherein W comprises a heteroatom or a bond; R₁ represents a substituent independently selected from the group consisting of: hydrogen, an alkyl group, an alkylhydroxy group, (C₁-C₅ alkyl)-R₂-(C₁-C₅ alkyl)₀₋₂, an alkoxy group, an amino group, a guanidine group, a thioalkoxy group, a thioalkyl group, a hydroxy group, a mercapto group, an allyl group, a vinyl group, a cyano group, a nitro group, an alkylamino group alkylamide group, carboxyethyl, carboxymethyl, a halo group, a haloalkyl group, an azo group and a carboxylic acid derivative or any combination thereof; and each R₃ is independently selected from the group consisting of: hydrogen, a linear C₁-C₄ alkyl group, a branched C₁-C₄ alkyl group, a substituted C₁-C₄ alkyl group, an alkylhydroxy group, carboxyethyl, carboxymethyl, a hydroxy group, a mercapto group, a halo group, a cyano group, an amino group, a nitro group, a sulfonate group, a sulfinyl group, and a sulfone group, an alkoxy group, a thioalkoxy group, a phosphine group, and a carboxylic acid derivative or any combination thereof; X is selected from the group consisting of: a C₁-C₁₀ alkyl group, hydrogen, a carboxylic acid derivative, —N(R₃)₂, —SR₃, —OR₃, —P(R₃)₂, phosphonate, phosphate, thiophosphate, —S(O)R₃, —S(O)₂R₃, —OS(O)₂R₃, —S(O)₂N(R₃)₂, an alkylhydroxy group, (C₁-c₅ alkyl)-R₂-(C₁-C₅ alkyl)₀₋₂, an alkylamide group, an alkylamino group, a thioalkyl group, an allyl group, and a haloalkyl group or any combination thereof; wherein at least one of W and R₁ comprises a heteroatom. In some embodiments, R₂ is as described herein. In some embodiments, at least one R₁ is devoid of hydrogen. In some embodiments, the compound represented by Formula IIIa comprises a plurality of R₁ being devoid of hydrogen. In some embodiments, if W is —O-, then R₁ is devoid of methyl.

In some embodiments, R₂ is selected from the group consisting of: an ester group, an amide, a carbamide, a carbamate, a thioester, a carbonate ester, N, S, O, P, phosphonate, phosphate, thiophosphate, —S(O)—, —S(O)₂—, —OS(O)₂—, —S(O)₂N- and

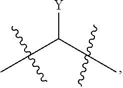

wherein Y is as described herein.

In some embodiments, the compound is represented by Formula IIIa, wherein if W is a bond, then at least one R₁ comprises any one of: an alkoxy group, an amino group, a thioalkoxy group, a thioalkyl group, a hydroxy group, a mercapto group, an aminoalkyl group, or any combination thereof.

In some embodiments, the compound is represented by Formula IIIb:

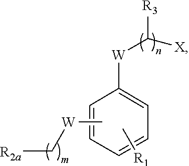

wherein X and R₃ are as described herein; R₁ represents a substituent independently selected from the group consisting of: hydrogen, an alkyl group, an alkylhydroxy group, (C₁-C₅ alkyl)-R₂-(C₁-C₅ alkyl)₀₋₂, an alkoxy group, an amino group, a guanidine group, a thioalkoxy group, a thioalkyl group, a hydroxy group, a mercapto group, an allyl group, a vinyl group, a cyano group, a nitro group, an alkylamino group alkylamide group, a halo group, a haloalkyl group, an azo group and a carboxylic acid derivative or any combination thereof; each W independently comprises a heteroatom or a bond, and at least one W comprises a heteroatom; n is from 1 to 3; m is from 0 to 5; and R₂a comprises a C₁-C₄ alkyl or hydrogen. In some embodiments, if W is —O-, then R₁ is devoid of methyl.

In some embodiments, at least one R₁ is devoid of hydrogen. In some embodiments, the compound represented by Formula IIIb comprises a plurality of R₁ being devoid of hydrogen.

In some embodiments, X is selected from the group consisting of: a carboxylic acid derivative, —N(R₂ₐ)₂, —SR₂ₐ, —OR₂ₐ, —P(R₃)₂ₐ, wherein R₂ₐ is as described herein.

In some embodiments, n is any of 1, 2 or 3. In some embodiments, m is any of 0, 1, 2, 3, 4 or 5.

In some embodiments, the compound is represented by Formula IIIb or by Formula IIIa, wherein at least one W comprises —O-.

In some embodiments, the compound is represented by any one of Formulae IIIc-IIIe:

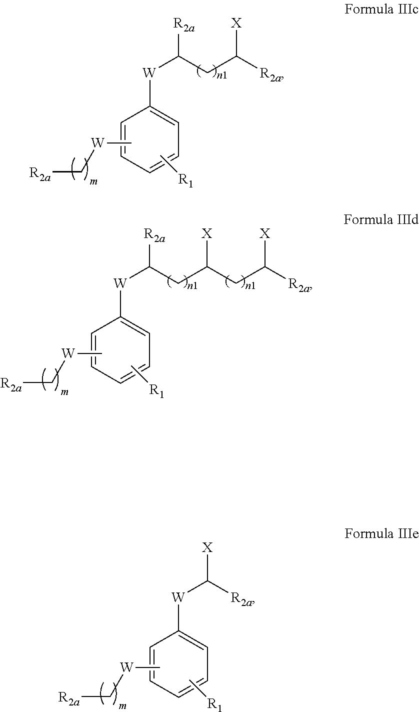

wherein each W independently comprises a heteroatom or a bond, and at least one W comprises a heteroatom; R₂ₐ is as described herein; R₁ represents a substituent independently selected from the group consisting of: hydrogen, an alkyl group, an alkylhydroxy group, (C₁-C₅ alkyl)-R₂-(C₁-C₅ alkyl)₀₋₂, an alkoxy group, an amino group, a guanidine group, a thioalkoxy group, a thioalkyl group, a hydroxy group, a mercapto group, an allyl group, a vinyl group, a cyano group, a nitro group, an alkylamino group alkylamide group, a halo group, a haloalkyl group, an azo group and a carboxylic acid derivative or any combination thereof; m is as described herein; n1 is from 0 to 3; and X is any one of

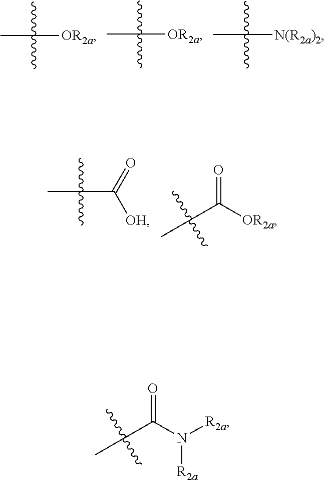

and if the compound is represented by Formula IIIc wherein X is carboxy, then n1 is 0. In some embodiments, n1 is 0, 1, 2, or 3. In some embodiments, if W is —O-, then R₁ is devoid of methyl.

In some embodiments, the compound is represented by Formula Inc, wherein at least one W is O and X is as described herein. In some embodiments, the compound is represented by Formula IIIc, wherein at least one W is O and X is —OH, —NH or —SH.

In some embodiments, R₂ is selected from the group consisting of: N, S, O, P, and

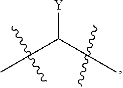

wherein Y is as described herein. In some embodiments, R₂ comprises

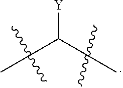

In some embodiments, the compound is represented by Formula Inc, wherein at least one W is O and X is:

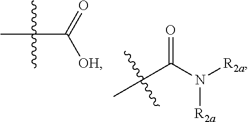

### or —OH.

In some embodiments, the compound is selected from the group consisting of:

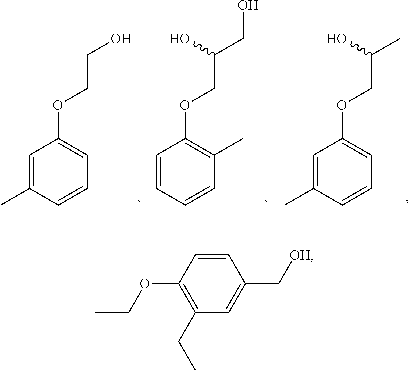

wherein a wavy bond represents an R-enantiomer, an S-enantiomer of the compound or a mixture thereof.

In some embodiments, the compound is represented by Formula IV:

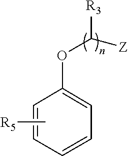

wherein:
Z is selected from the group consisting of: a carboxylic acid derivative, —N(R₃)₂, —SR₃, —OR₃, —P(R₃)₂, phosphonate, phosphate, thiophosphate, —S(O)R₃, —S(O)₂R₃, —OS(O)₂R₃, and —S(O)₂N(R₃)₂ or any combination thereof; n is between 1 and 3; R₅ is selected from the group consisting of: a linear C₂-C₆ alkyl group, a branched C₂-C₆ alkyl group, a substituted C₂-C₆ alkyl group, an alkylhydroxy group, a hydroxy group, a mercapto group, a vinyl group, and an allyl group or any combination thereof;
and each R₃ is independently selected from the group consisting of: hydrogen, a linear C₁-C₄ alkyl group, a branched C₁-C₄ alkyl group, a substituted C₁-C₄ alkyl group, an alkylhydroxy group, a hydroxy group, a mercapto group, a halo group, a cyano group, an amino group, a nitro group, a sulfonate group, a sulfinyl group, and a sulfone group, an alkoxy group, a thioalkoxy group, a phosphine group, and a carboxylic acid derivative or any combination thereof.

In some embodiments, the compound of Formula IV comprises one or two substituents represented by R₅, as described hereinabove. In some embodiments, R₅ represents one substituent, being selected from the group consisting of: a linear C₂-C₆ alkyl group, a branched C₂-C₆ alkyl group, a substituted C₂-C₆ alkyl group, an alkylhydroxy group, a vinyl group, and an allyl group or any combination thereof.

In some embodiments, R₅ is a linear C₂-C₆ alkyl group, a branched C₂-C₆ alkyl group, or a substituted C₂-C₆ alkyl group or any combination thereof. In some embodiments, R₅ is a branched C₂-C₆ alkane group. In some embodiments, R₅ is selected from: iso-propyl, iso-butyl, tert-butyl, iso-pentyl, neo-pentyl or any combination thereof.

In some embodiments, Z is selected from a carboxylic acid derivative, and —N(R₃)₂. In some embodiments, Z is an amide group. In some embodiments, Z is an unsubstituted amide group. In some embodiments, Z is an optionally N-substituted amide group.

In some embodiments, Z is a thioamide group. In some embodiments, Z is an optionally N-substituted thioamide group.

In some embodiments, the compound of Formula IV comprises one to three substituents represented by R₃, as described hereinabove. In some embodiments, each R₃ is independently selected from the group consisting of: hydrogen, a linear C₁-C₄ alkyl group, a hydroxy group, a mercapto group, a halo group, a cyano group, an amino group, a nitro group, and a sulfonate group or any combination thereof.

In some embodiments, each R₃ is independently selected from the group consisting of: hydrogen, a linear C₁-C₄ alkyl group, a hydroxy group, and a halo group or any combination thereof. In some embodiments, each R₃ is independently selected from hydrogen, or a linear C₁-C₄ alkane group. In some embodiments, R₃ is hydrogen.

In some embodiments, the compound is represented by Formula IVa:

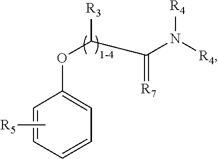

wherein:
R₃ and R₅ are as described hereinabove;
each R₄ is independently selected from the group consisting of: hydrogen, a linear C₁-C₄ alkane group, a branched C₁-C₄ alkane group and a substituted C₁-C₄ alkane group;

### and R₇ is O or S.

In some embodiments, the compound is represented by Formula IVb:

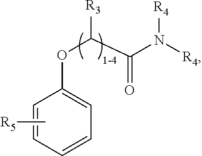

wherein R₃, R₄, and R₅ are as described hereinabove.

In some embodiments, the compound of Formula IVb comprises one substituent represented by R₅. In some embodiments, R₅ is positioned ortho or metha to O. In some embodiments, R₅ is positioned ortho to O.

In some embodiments, R₄ is independently selected from hydrogen, and a linear C₁-C₄ alkane group. In some embodiments, R₄ is a linear C₁-C₄ alkane group. In some embodiments, R₄ is methyl.

In some embodiments, the compound is any one of:

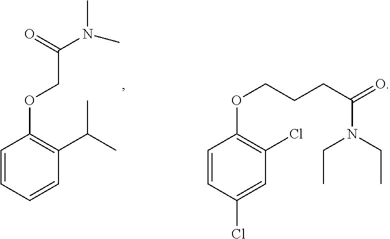 [SMILES: CC(C)c1ccccc1OCC(=O)N(C)C ; CCN(CC)C(=O)CCCOc1ccc(Cl)cc1Cl]

In some embodiments, the compound is represented by Formula V:

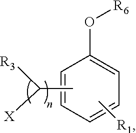

wherein:
X is selected from the group consisting of: a C₁-C₁₀ alkyl group, hydrogen, a carboxylic acid derivative, —N(R₃)₂, —SR₃, —OR₃, —P(R₃)₂, phosphonate, phosphate, thiophosphate, —S(O)R₃, —S(O)₂R₃, —OS(O)₂R₃, —S(O)₂N(R₃)₂, an alkylhydroxy group, (C₁-C₅ alkyl)-R₂-(C₁-C₅ alkyl)₀₋₂, an alkylamide group, an alkylamino group, a thioalkyl group, an allyl group, and a haloalkyl group or any combination thereof; each R₃ is independently selected from the group consisting of: hydrogen, a linear C₁-C₄ alkyl group, a hydroxy group, a mercapto group, a halo group, a cyano group, an amino group, a nitro group, a carboxylic acid derivative, and a sulfonate group or any combination thereof; R₁ is selected from the group consisting of hydrogen, an alkyl group, an alkylhydroxy group, (C₁-C₅ alkyl)-R₂-(C₁-C₅ alkyl)₀₋₂, an alkoxy group, an amino group, a guanidine group, a thioalkoxy group, a thioalkyl group, a hydroxy group, a mercapto group, an allyl group, a vinyl group, a cyano group, a nitro group, an alkylamino group alkylamide group, a halo group, a haloalkyl group, an azo group and a carboxylic acid derivative or any combination thereof; n represents an integer between 1 and 3; and each R₆ is independently selected from the group consisting of: a linear C₁-C₆ alkyl group, a branched C₁-C₆ alkyl group, a substituted C₁-C₆ alkyl group, an alkylhydroxy group, a vinyl group, hydrogen, and an allyl group or any combination thereof.

In some embodiments, X is selected from the group consisting of: a carboxylic acid derivative, —N(R₃)₂, —SR₃, —OR₃, —P(R₃)₂, phosphonate, phosphate, thiophosphate, —S(O)R₃, —S(O)₂R₃, —OS(O)₂R₃, and —S(O)₂N(R₃)₂ or any combination thereof. In some embodiments, X is selected from the group consisting of: —N(R₃)₂, —SR₆, —OR₆, and —P(R₆)₂ or any combination thereof.

In some embodiments, an alkyl substituent is positioned at any of the ortho, meta, or para positions relative to OR₆. In some embodiments, an alkyl substituent is positioned ortho or meta relative to OR₆. In some embodiments, an alkyl substituent is positioned ortho relative to OR₆.

In some embodiments, X is selected from the group consisting of: a carboxylic acid derivative, —N(R₃ₐ)₂, —SR₃ₐ, —OR₃ₐ, —P(R₃ₐl ), a C₁-C₄ alkyl group, and hydrogen or any combination thereof, wherein R₃ₐ represents a C₁-C₄ alkyl. In some embodiments, X is —N(R₃ₐ)₂, or —OR₃ₐ.

In some embodiments, the compound is represented by Formula VA:

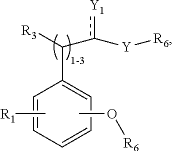

wherein: R₆, R₁ and R₃ are as described hereinabove; dashed bond represents a single bond or a double bond; Y₁ comprises a heteroatom or is absent; Y represents a bond or a substituent selected from the group consisting of: —N(R₆)₂, —SR₆, —OR₆, and —P(R₆)₂; and wherein at least one of R₃ and Y₁ comprises a heteroatom.

In some embodiments, the compound is represented by Formula VA, and if Y₁ is absent, then R₃ represents a substituent selected from the group consisting of: —N(R₆)₂, —SR₆, —OR₆, or any combination thereof. In some embodiments, the compound is represented by Formula VA, and if R₃ is hydrogen, then Yi represents a substituent selected from the group consisting of: —N(R₆)₂, —SR₆, —OR₆, or any combination thereof.

In some embodiments, the compound is represented by Formula VA, wherein: Y represents a bond or a substituent selected from the group consisting of: —N(R₆)₂, —SR₆, —OR₆, and —P(R₆)₂ or any combination thereof; R₁ comprises hydrogen, a halo group or a C₁-C₄ alkyl group, and each R₃ independently represents a substituent selected from the group consisting of: hydrogen, —N(R₆)₂, —SR₆, —OR₆, —P(R₆)₂ and C₁-C₄ alkyl or any combination thereof; and wherein at least one of R₃ and Y₁ comprises a heteroatom.

In some embodiments, the compound is represented by Formula VA1:

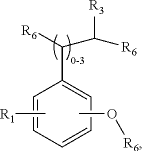

wherein R₃ is selected from the group consisting of hydroxy group, C₁-C₄ alkoxy group, amino group, C₁-C₄ alkylamino group, C₁-C₄ thioalkyl group, and mercapto group, R₆ represents C₁-C₄ alkyl group or hydrogen and R₁ is as described hereinabove.

In some embodiments, the compound is any of:

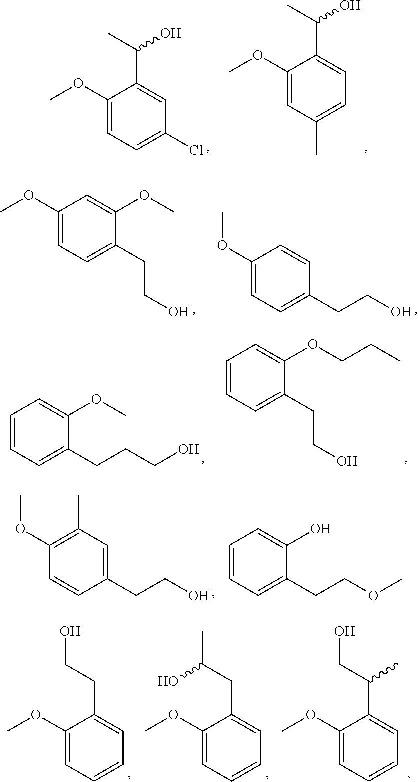

wherein a wavy bond represents an R-enantiomer, an S-enantiomer of the compound or a mixture thereof.

In some embodiments, the compound is represented by Formula Va:

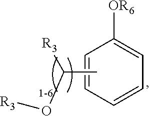

wherein R₆, and R₃ are as described hereinabove.

In some embodiments, each R₃ is independently selected from hydrogen, and a linear C₁-C₄ alkane group. In some embodiments, R₃ is hydrogen.

In some embodiments, C₁-C₄ alkane or C₁-C₄ alkyl group comprises C₁-C₂ alkane, C₁-C₃ alkane, C₂-C₃ alkane, C₃-C₄ alkane, including any range between. In some embodiments, C₁-C₄ alkane group comprises methyl, ethyl, butyl, isobutyl, sec-butyl, tert-butyl, or any combination thereof.

In some embodiments, C₁-C₆ alkane or C₁-C₆ alkyl group comprises C₁-C₂ alkane, C₁-C₃ alkane, C₂-C₃ alkane, C₃-C₄ alkane, C₄-C₅ alkane, C₅-C₆ alkane, including any range between. In some embodiments, C₁-C₆ alkane group comprises methyl, ethyl, butyl, isobutyl, sec-butyl, tert-butyl, pentyl, iso-pentyl, sec-pentyl, tert-pentyl, neo-pentyl, 3-pentyl, sec-isopentyl, hexyl, cyclohexyl, a branched hexyl or any combination thereof.

In some embodiments, R₆ is selected from the group consisting of: a linear C₁-C₆ alkane group, a branched C₁-C₆ alkane group, and a substituted C₁-C₆ alkane group. In some embodiments, R₆ is selected from the group consisting of: a linear C₁-C₄ alkane group, a branched C₁-C₄ alkane group, and a substituted C₁-C₄ alkane group, wherein substituted is as described herein. In some embodiments, R₆ is a linear C₁-C₄ alkane group, as described herein. In some embodiments, R₆ is methyl.

In some embodiments, the compound is represented by Formula VI:

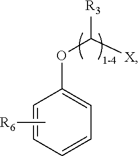

wherein X, and R₃ are as described hereinabove;
and R₆ represents one to three substituents.

In some embodiments, the compound is represented by Formula VIa:

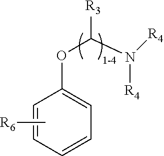

wherein R₆, and R₃ are as described hereinabove;

and each R₄ is independently selected from the group consisting of: hydrogen, a linear C₁-C₄ alkane group, a branched C₁-C₄ alkane group and a substituted C₁-C₄ alkane group.

In some embodiments, each R₃ is independently selected from hydrogen, and a linear C₁-C₄ alkane group. In some embodiments, R₃ is hydrogen. In some embodiments, each R₃ is methyl.

In some embodiments, R₆ is a linear C₁-C₆ alkane group. In some embodiments, R₆ is methyl.

In some embodiments, R₄ is independently selected from hydrogen, and a linear C₁-C₄ alkane group. In some embodiments, R₄ is hydrogen. In some embodiments, the compound is selected from:

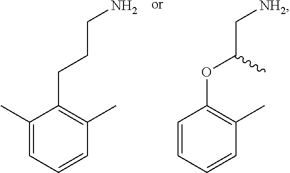

wherein the wavy bond is as described herein.

In some embodiments, the compound of the invention substantially comprises R-enantiomer, S-enantiomer or a mixture thereof, wherein substantially is as described herein.

In some embodiments, the compound of the invention comprises

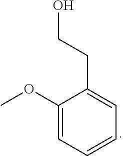

In some embodiments, the compound of the invention comprises

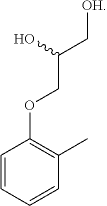

In some embodiments, the compound of the invention comprises

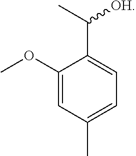

In some embodiments, the compound of the invention comprises

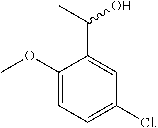

In some embodiments, the compound of the invention comprises

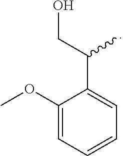

In some embodiments, the compound of the invention comprises

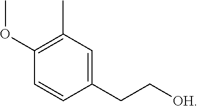

In some embodiments, the compound of the invention comprises

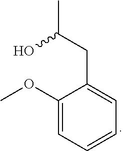

In some embodiments, the compound of the invention comprises

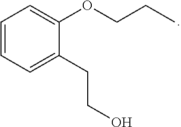

In some embodiments, the compound of the invention comprises

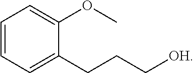

In some embodiments, the compound of the invention comprises

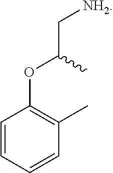

In some embodiments, the compound of the invention comprises

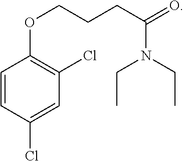 [SMILES: CCN(CC)C(=O)CCCOc1ccc(Cl)cc1Cl]

In some embodiments, the compound of the invention comprises

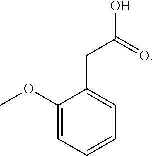

In some embodiments, the compound of the invention comprises

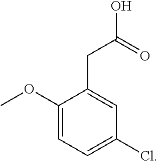

### Thiazole Derivatives

According to another aspect of the present invention, there is provided a herbicidal composition comprising a compound represented by Formula I:

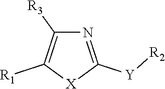

wherein:
X is selected from N, S, and O; R₁ and Y are independently selected from the group consisting of: a nitro group, a hydroxy group, a carboxylic acid derivative, a halo group, a cyano group, a sulfinyl group, a sulfone group, a sulfonate group, a keto group, formyl, a haloalkyl group, —N(C₁-C₅), an azo group, O, P, N, NH, S, C, an optionally substituted C₄-C₂₀ cycloalkyl group, an optionally substituted C₅-C₂₀ heterocyclyl group, an optionally substituted aryl group, and a heteroaryl group or any combination thereof; R₂ represents a substituent independently selected from the group consisting of: hydrogen, an alkylhydroxy group, an alkoxy group, a thioalkoxy group, a thioalkyl group, an optionally substituted C₄-C₂₀ alkyl group, an optionally substituted C₄-C₂₀ cycloalkyl group, an optionally substituted C₄-C₂₀ bicyclic ring, an optionally substituted C₄-C₂₀ heterocyclyl group, an optionally substituted aryl group, an
optionally substituted heteroaryl, and

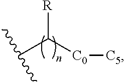

or any combination thereof, or R₂ is absent; each R is independently selected from the group consisting of: an optionally substituted C₄-C₂₀ heterocyclyl, an optionally substituted C₄-C₂₀ cycloalkyl group, a mercapto group, an amino, a hydroxy group, a halo group, a cyano group, a nitro group, a carboxylic acid derivative, and an optionally substituted C₁-C₁₀ alkyl group comprising a heteroatom or any combination thereof; each n is independently 1 to 3; R₃ is selected from the group consisting of: an alkyl group, an alkylhydroxy group, an alkoxy group, a halo group, a haloalkyl group, a nitro group, a hydroxy group, a sulfinyl group, a sulfone group, and a sulfonate group or any combination thereof, or R₃ is absent; and if Y comprises a nitro group, a hydroxy group, a halo group, or a cyano group then R₂ is absent.

In some embodiments, the herbicidal composition comprises the compound, an agriculturally acceptable salt of the compound or both.

In some embodiments, Y is NH, and R₂ is selected from the group consisting of: hydrogen, an optionally substituted C₄-C₈ alkyl group, an optionally substituted C₄-C₆ heterocyclyl group, an optionally substituted C₄-C₆ cycloalkyl group, a C₆-C₁₂ heterocyclyl, and

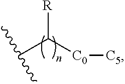

or any combination thereof.

In some embodiments, the composition further comprises a herbicidally active derivative of the compound. The term “herbicidally active derivative” refers to any derivative of the compound exhibiting a herbicidal activity, or to a derivative which undergoes a chemical transformation, e.g. in plants, water, or in soil, and thus becoming herbicidally active. An example of such derivative is an ester, which hydrolyses in plants or soil, thereby releasing an active compound of the invention.

In some embodiments, the compound is represented by Formula Ia:

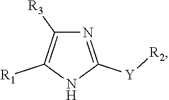

wherein Y, R₁, R₂ and R₃ are as defined hereinabove.

In some embodiments, the compound is represented by Formula Ib:

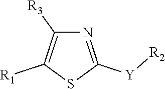

wherein Y, R₁, R₂ and R₃ are as defined hereinabove.

In some embodiments, Y is selected from O, P, N, S, C, a C₄-C₂₀ cycloalkyl group, a nitro group, a C₅-C₂₀ heterocyclyl group, an aryl group, and a heteroaryl group.

In some embodiments, Y is selected from O, N, S, a C₅-C₂₀ cycloalkyl group, a nitro group, a C₅-C₁₀ heterocyclyl group, an aryl group, a heteroaryl group.

In some embodiments, Y is selected from N, S, a nitro group, a C₅-C₆ heterocyclyl group, and a C₅-C₆ heteroaryl group.

In some embodiments, R₁ is selected from the group consisting of: a nitro group, chloro, a hydroxy group, a sulfinyl group, a sulfone group, a sulfonate group, a keto group, formyl, a haloalkyl group, a cyano group, a trialkylammonium group, and an azo group.

In some embodiments, the compound comprises a substituent represented by R₃. In some embodiments, R₃ is selected from the group consisting of: hydrogen, an alkyl group, an alkylhydroxy group, an alkoxy group, a halo group, a haloalkyl group, a nitro group, a hydroxy group, a sulfinyl group, a sulfone group, and a sulfonate group.

In some embodiments, R₃ is selected from the group consisting of: hydrogen, a halo group, and a C₁-C₅ alkyl group.

In some embodiments, the compound is any of:

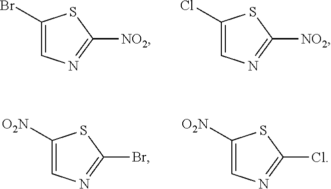 [SMILES: O=[N+]([O-])c1ncc(Br)s1 ; O=[N+]([O-])c1ncc(Cl)s1 ; O=[N+]([O-])c1cnc(Br)s1 ; O=[N+]([O-])c1cnc(Cl)s1]

In some embodiments, the compound is represented by any one of Formulae Ic-g:

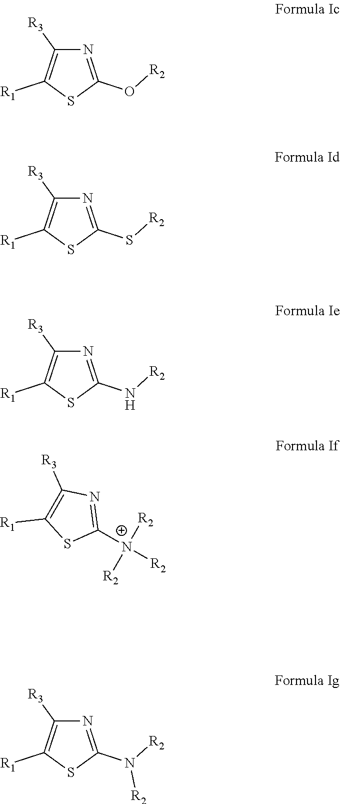

In some embodiments, the compound is represented by Formula Ih:

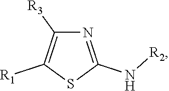

wherein R₂ is selected from the group consisting of: hydrogen, a C₄-C₈ alkyl group, a C₄-C₆ heterocyclyl group, a C₄-C₆ cycloalkyl group, a C₆-C₁₂ alkyl group comprising a

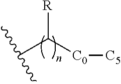

heteroatom, and or any combination thereof; and R₁, R and R₃ are as described hereinabove.

In some embodiments, R₂ is selected from the group consisting of: hydrogen, a C₄-C₈ alkane group, a C₄-C₈ alkane group comprising 1 to 3 substituents, and

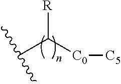

or any combination thereof.

In some embodiments, the compound is represented by Formula II:

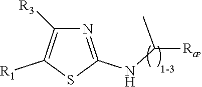

wherein R₁ and R₃ are as defined hereinabove; and each Ra is independently selected from the group consisting of: hydrogen, a C₁-C₁₂ alkyl group, a C₄-C₂₀ heterocyclyl group, a C₄-C₂₀ cycloalkyl group, a mercapto group, an amino, a hydroxy group, a halo group, a cyano group, and a nitro group or any combination thereof, and wherein at least one Rₐ is selected from the group consisting of: a C₄-C₆ cycloalkane group, a C₆-C₈ bridged cycloalkane group or any combination thereof.

In some embodiments, the compound represented by Formula II comprises one or two substituents represented by Rₐ. In some embodiments, the compound represented by Formula II comprises one Rₐ. In some embodiments, Rₐ is selected from the group consisting of: a C₄-C₆ cycloalkane group, a C₆-C₈ bridged cycloalkane group, and at least one Rₐ is a C₆-C₈ bridged cycloalkane group.

In some embodiments, the compound is represented by Formula IIa:

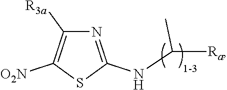

wherein R₃ₐ is selected from the group consisting of: hydrogen, a C₁-C₅ alkyl group, an alkylhydroxy group, an alkoxy group, a nitro group, a hydroxy group, a sulfinyl group, a sulfone group, and a sulfonate group;
and Rₐ is as defined hereinabove.

In some embodiments, R₃ₐ is selected from the group consisting of: hydrogen, a halo group, and a C₁-C₅ alkyl group. In some embodiments, R₃ₐ is hydrogen.

In some embodiments, Rₐ is a C₇ bridged cycloalkane group. In some embodiments, Rₐ is bicyclo[2.2.1]heptane.

In some embodiments, R₃ₐ is hydrogen and Ra is bicyclo[2.2.1]heptane.

In some embodiments, the compound is represented by Formula IIb:

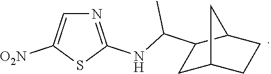 [SMILES: CC(Nc1ncc([N+](=O)[O-])s1)C1CC2CCC1C2]

In some embodiments, the compound of Formula I is represented by Formula III:

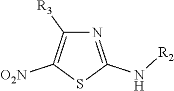

wherein R₂ and R₃ are as defined hereinabove.

In some embodiments, R₂ is selected from the group consisting of: a C₄-C₈ alkane group comprising 1 to 3 substituents, hydrogen, a C₄-C₈ alkane group, and

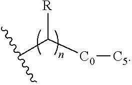

In some embodiments, R₂ is

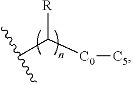

wherein: n is any of 1, 2 or 3; C₀-C₅ is absent or comprises a C₁-C₅ alkyl, a C₁-C₂ alkyl, a C₂-C₃ alkyl, a C₃-C₄ alkyl, a C₄-C₅ alkyl, including any range between; R is selected from the group consisting of: hydrogen, a mercapto group, an amino, a hydroxy group, a halo group, a cyano group, a nitro group, and a carboxylic acid derivative, and wherein at least one R is selected from a mercapto group, an amino, a hydroxy group, a halo group, a cyano group, and a nitro group.

In some embodiments, R₂ comprises one substituent represented by R. In some embodiments, R₂ comprises one substituent represented by R, wherein R is selected from a hydroxy group, a mercapto group, and a halo group. In some embodiments, R₂ is a C₂-C₄ alkylhydroxy group.

In some embodiments, R₂ is a C₄-C₈ alkane group comprising 1 to 3 substituents. In some embodiments, R₂ is a C₄-C₈ alkane group comprising 1 to 3 substituents selected from the group consisting of: a hydroxy group, an amino group, a cyano group, a halo group, and a mercapto group.

In some embodiments, R₃ is a halo group. In some embodiments, R₃ is a halo group and R₂ is hydrogen. In some embodiments, R₃ is a halo group and R₂ is a C₁-C₅ alkyl group. In some embodiments, R₃ is a halo group and R₂ is a C₂-C₄ alkylhydroxy group.

In some embodiments, R₃ is a C₁-C₅ alkyl group and R₂ is hydrogen. In some embodiments, R₃ is a C₁-C₅ alkyl group and R₂ is a C₄-C₈ alkane group. In some embodiments, R₃ is a C₁-C₅ alkyl group and R₂ is a substituted C₄-C₈ alkane group comprising 1 to 3 substituents. In some embodiments, R₃ is a C₁-C₅ alkyl group and R₂ is a C₂-C₄ alkylhydroxy group.

In some embodiments, R₃ and R₂ are hydrogens. In some embodiments, R₃ is hydrogen and R₂ is a C-C₈ alkane group. In some embodiments, R₃ is hydrogen and R₂ is a C₄-C₈ alkane group. In some embodiments, R₃ is hydrogen and R₂ is a C₂-C₄ alkylhydroxy group.

In some embodiments, the compound is selected from the group consisting of:

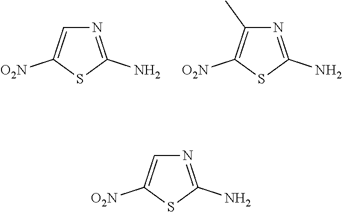

In some embodiments, the compound is selected from the group consisting o

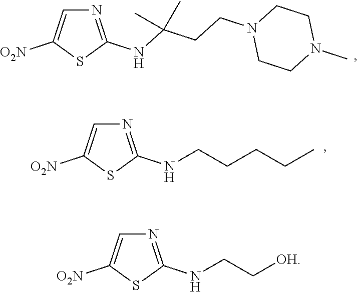 [SMILES: CN1CCN(CCC(C)(C)Nc2ncc([N+](=O)[O-])s2)CC1 ; CCCCCNc1ncc([N+](=O)[O-])s1 ; O=[N+]([O-])c1cnc(NCCO)s1]

In some embodiments, the compound is represented by Formula IIIa:

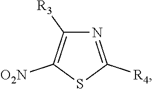

wherein:
R₃ is selected from a C₁-C₅ alkyl group, a halo group, and hydrogen or any combination thereof; and R₄ is selected from the group consisting of: hydrogen, a C₃-C₉ heterocyclyl group, and a C₅-C₉ heteroaryl group or any combination thereof.

In some embodiments, R₄ is a C₃-C₉ heterocyclyl group.

In some embodiments, C₃-C₉ heterocyclyl group comprises C₃-C₅ heterocyclyl, C₅-C₆ heterocyclyl group, C₅-C₈ heterocyclyl group, C₅-C₇ heterocyclyl group or any range therebetween.

In some embodiments, R₄ is selected from the group consisting of: pyrrole, pyrrolidine, pyridine, morpholine, piperidine, hydroxy piperidine, indole, isoindole, thiazole, imidazole, and oxazole or any combination thereof.

In some embodiments, the compound is selected from the group consisting of:

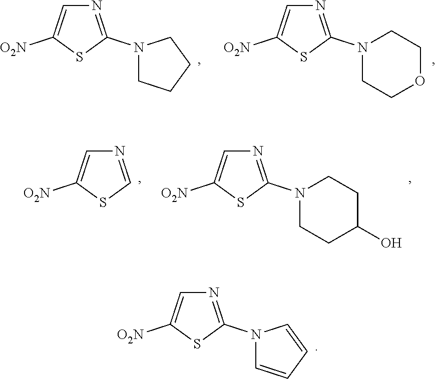 [SMILES: O=[N+]([O-])c1cnc(N2CCCC2)s1 ; O=[N+]([O-])c1cnc(N2CCOCC2)s1 ; O=[N+]([O-])c1cncs1 ; O=[N+]([O-])c1cnc(N2CCC(O)CC2)s1 ; O=[N+]([O-])c1cnc(-n2cccc2)s1]

In some embodiments, the compound is represented by Formula IV:

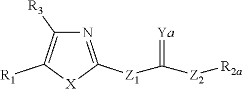

wherein:
X is selected from N, S, and O; Yₐ is selected from O, N, and S; Z₁ is selected from O, N, C, and S; Z₂ is selected from H, O, N, C, and S, or is absent; R₁ is selected from the group consisting of: a nitro group, a hydroxy group, a sulfinyl group, a sulfone group, a sulfonate group, a keto group, formyl, a haloalkyl group, a cyano group, a trialkylammonium group and an azo group or any combination thereof; R₂ₐ is selected from the group consisting of: a C₁-C₅ haloalkyl group, a C₅-C₁₀ cycloalkyl group, a C₅-C₁₀ alkyl group, —(CH₂)ₚ-T-(CH₂)ₒ, C₀-C₅ alkaryl optionally substituted by R₅, and

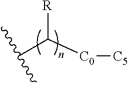

or any combination thereof, and wherein: T is selected from O, S and N, p is 1 to 4, o is 1 to 5, and if T is O and p is 1 then o is selected from 1, 3, 4 and 5.
and R₅ is selected from the group consisting of: hydrogen, a halo group, a C₁-C₅ alkyl group, an C₁-C₅ alkoxy group, a C₁-C₅ thioalkoxy group, a carboxylic acid derivative, a hydroxy group, a mercapto group, a sulfinyl group, a sulfone group, a sulfonate group, a cyano group, and an azo group or any combination thereof.

In some embodiments, R₃ is selected from the group consisting of: hydrogen, an alkyl group, an alkylhydroxy group, an alkoxy group, a haloalkyl group, a nitro group, a hydroxy group, a sulfinyl group, a sulfone group, and a sulfonate group or any combination thereof.

In some embodiments, R₅ represents a substituent selected from the group consisting of: hydrogen, a halo group, an alkyl group, an alkoxy group, a thioalkoxy group, a carboxylic acid derivative, a hydroxy group, a mercapto group, a sulfinyl group, a sulfone group, a sulfonate group, a cyano group, and an azo group or any combination thereof.

In some embodiments, R₅ is selected from the group consisting of: hydrogen, a halo group, an alkyl group, a hydroxy group, a cyano group, and a mercapto group or any combination thereof. In some embodiments, R₅ represents one substituent. In some embodiments, R₅ represents one substituent and m is 0 or 1.

In some embodiments, the compound is selected from:

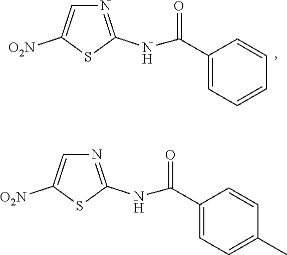 [SMILES: O=C(Nc1ncc([N+](=O)[O-])s1)c1ccccc1 ; Cc1ccc(C(=O)Nc2ncc([N+](=O)[O-])s2)cc1]

In some embodiments, R₂ₐ is selected from the group consisting of: hydrogen, a haloalkyl group, a C₅-C₁₀ alkyl group, —(CH₂)p-T-(CH₂)o, a C₆ aryl group, and a C₆ heteroaryl group, or any combination thereof, or is absent.

In some embodiments, R₂ₐ is selected from the group consisting of: hydrogen, a C₁-C₅ haloalkane group, a C₅-C₁₀ alkane group, —(CH₂)p-T-(CH₂)o, a C₆ aryl group,

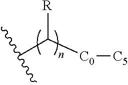

a C₆ heteroaryl group, and or is absent.

In some embodiments, each R is independently selected from the group consisting of: hydrogen, a C₁-C₁₂ alkyl group, an aryl group, a C₄-C₂₀ cycloalkyl group, a mercapto group, an amino group, a hydroxy group, a keto group, a halo group, a cyano group, a nitro group, and a carboxylic acid derivative or any combination thereof.

In some embodiments, each R is independently selected from the group consisting of: hydrogen, a C₁-C₁₂ alkyl group, a mercapto group, an amino group, a hydroxy group, a halo group, a cyano group, and a nitro group or any combination thereof.

In some embodiments, R₃ is selected from hydrogen, and an alkyl group.

In some embodiments, R₁ is selected from the group consisting of: a nitro group, a hydroxy group, a sulfinyl group, a sulfone group, a sulfonate group, a keto group, and formyl or any combination thereof.

In some embodiments, R₁ is selected from the group consisting of: a nitro group, a hydroxy group, a sulfinyl group, a sulfone group, a sulfonate group, and formyl or any combination thereof.

In some embodiments, the compound is represented by Formula V:

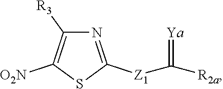

wherein R₂ₐ, R₃, Yₐ and Z₁ are as defined hereinabove.

In some embodiments, Zi is selected from O, and N. In some embodiments, Z₁ is N, and Yₐ is 0.

In some embodiments, the compound is represented by Formula Va:

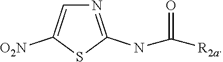

In some embodiments, the compound is selected from the group consisting of:

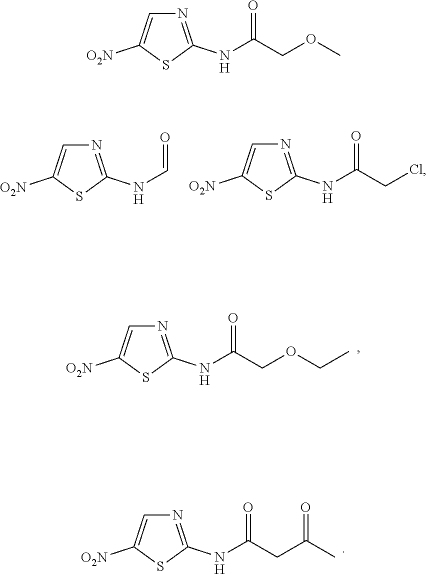

In some embodiments, the compound is represented by Formula VI:

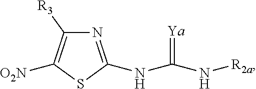

wherein R₂ₐ, R₃, and Yₐ are as defined hereinabove.

In some embodiments, Yₐ is selected from O, and S.

In some embodiments, R₃ is hydrogen or a C₁-C₅ alkane. In some embodiments, R₃ is an optionally substituted C₁-C₅ alkane. In some embodiments, R₃ is hydrogen.

In some embodiments, R₂ₐ is selected from the group consisting of: a C₅-C₁₀ alkane group, a C₆ aryl group, and a C₆ heteroaryl group. In some embodiments, R₂ₐ is selected from the group consisting of: an optionally substituted C₅-C₁₀ alkane group, an optionally substituted C₆ aryl group, and an optionally substituted C₆ heteroaryl group.

In some embodiments, the compound is selected from:

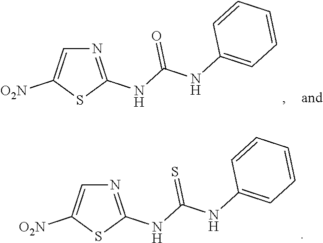 [SMILES: O=C(Nc1ccccc1)Nc1ncc([N+](=O)[O-])s1 ; O=[N+]([O-])c1cnc(NC(=S)Nc2ccccc2)s1]

In some embodiments, the compound is selected from the group consisting of:

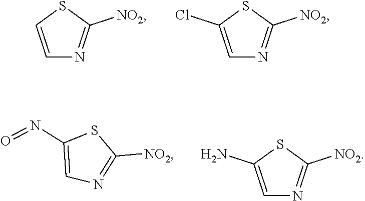 [SMILES: O=[N+]([O-])c1nccs1 ; O=[N+]([O-])c1ncc(Cl)s1 ; O=Nc1cnc([N+](=O)[O-])s1 ; Nc1cnc([N+](=O)[O-])s1]

In some embodiments, the compound of the invention substantially comprises a single enantiomer of any one of the compounds described herein, wherein substantially is at least 70%, at least 75%, at least 80%, at least 85%, at least 90%, at least 92%, at least 93%, at least 95%, at least 97%, at least 98%, at least 99% by weight, including any value therebetween.

In some embodiments, the compound of the invention comprises a mixture (e.g. racemic mixture) of enantiomers.

In some embodiments, the compound of the invention comprises a mixture of R-enantiomer and S-enantiomer, wherein the weight per weight (w/w) ratio between the R-enantiomer and the S-enantiomer is between 1:10 and 10:1, between 1:1 and 1:3, between 1:3 and 1:5, between 1:5 and 1:10, between 10:1 and 8:1, between 8:1 and 5:1, between 5:1 and 3:1, between 3:1 and 1:1 including any range or value therebetween.

In some embodiments, the compound of the invention comprises a salt of any one of the compounds disclosed herein. In some embodiments, the compound of the invention comprises a carboxylate salt. In some embodiments, the carboxylate salt comprises an agriculturally acceptable cation. In some embodiments, the compound of the invention comprises an ammonium salt. In some embodiments, the ammonium salt comprises an agriculturally acceptable anion.

### Method of Treatment

In some embodiments, the present invention provides a method of controlling the growth of a plant, comprising applying to the plant, parts of the plant, seeds of the plant, and the area under cultivation a herbicidally effective amount of a composition of the invention. In some embodiments, the method of invention comprises contacting a plant, a part of the plant, a seed of the plant, or the area under cultivation with the composition or the herbicidal composition of the invention. In some embodiments, contacting comprises applying herbicidally effective amount of the composition of the invention to a plant, a part of the plant, a seed of the plant, or the area under cultivation, wherein herbicidally effective amount is as described herein.

In another embodiment of the invention, there is provided a method for preventing the growth of a plant. In some embodiments, the method is for preventing germination of seeds. In some embodiments, the method is for destroying a plant. In some embodiments, the plant is a crop. In some embodiments, the plant is a broad-leaved plant. In some embodiments, the plant is a weed.

The term ‘herbicide’ as used herein denotes a compound which controls or modifies the growth of plants. The term ‘herbicidally effective amount’ indicates the quantity of such a compound or combination of such compounds which can control or modify the growth of plants. The term “control or modify” include all deviation from natural development, such as: killing, retardation, leaf burn, albinism, dwarfing, germination prevention and the like. For example, plants that are not killed are often stunted and non-competitive with flowering disrupted. The term ‘plants’ refers to all physical parts of a plant, including seeds, seedlings, saplings, roots, tubers, stems, stalks, foliage, fruits, plants emerging from vegetative propagules, immature vegetation, and established vegetation.

The herbicidal composition of the present invention may be used against any plants growing in an undesired location. For example, the composition of the invention may be used against a large number of agronomically important weeds, including, but not limited to, monocotyledonous weeds and dicotyledonous weeds. In some embodiments, the method of the invention comprises contacting a plant, a part of the plant, a seed of the plant, or the area under cultivation with the herbicidal composition of the invention, wherein the herbicidal composition is devoid of an additional agricultural composition (e.g. a pesticidal composition, a fungicidal composition etc.)

Non-limiting examples of Dicotyledon weeds are: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum nigrum, Rorippa, Rotala, Lindernia, Lamium, Veronica, Emex, Datura, Viola, Galeopsis, Papaver, Trifolium, Abutilon, and Centaurea.

Non-limiting examples of Monocotyledon weeds are: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbris tylis, Sagittaria, Eleocharis, Scirpus, Paspalum, Ischaenum, Sphenoclea, Dactyloctenium, Agrostis, Alopecurus and Apera.

As defined herein, the term “weeds” includes undesirable crop species such as volunteer crops. For example, a crop species growing in an area where a different crop is being cultivated may be considered a ‘volunteer’ .

As defined herein, the term “area under cultivation” is intended to include fields, hard landscapes such as driveways, paths, patios, roads, pavements, railways and the like, as well as soil, or established vegetation.

In some embodiments, the herbicidal composition is applied, depending on the concentration, for controlling weeds in field crops such as: Zea, Oryza, Triticum, Hordeum, Avena, Secale, Sorghum, Panicum, Solanum, Ananas, Asparagus, Fagopyrum, Phaseolus, and Allium.

In some embodiments, the herbicidal composition is applied for selective weed control in field crops. In some embodiments, the method of the invention comprises applying the herbicidal composition for controlling growth of a specific weed (e.g. Amaranthus palmeri). In some embodiments, the method of the invention comprises applying the herbicidal composition for controlling growth of a plurality of weeds (e.g. Amaranthus palmeri, Solanum nigrum, Abutilon theophrasti, Lactuca sativa, Sinapis alba, Datura ferox, Echinochloa colonum, Setaria adhaerens, or any combination thereof).

In some embodiments, the herbicidal composition is applied, depending on the concentration, for controlling weeds in crops (e.g. perennial cultures) such as: decorative tree plantings, fruit orchards, vineyards, citrus groves, nut orchards, banana plantations, coffee plantations, tea plantations, rubber plantations, oil palm plantations, cocoa plantations, soft fruit plantings and hop fields, and for the selective combating of weeds in annual cultures.

In some embodiments, the herbicidal composition is applied to a plant for growth regulation. In some embodiments, the method of the invention comprises applying the herbicidal composition systemically to the area under cultivation (e.g. systemic herbicide). In some embodiments, the method of the invention comprises applying the herbicidal composition locally to the plant or a part of the plant (e.g. contact herbicide).

In some embodiments, the herbicidal composition is applied to a plant or to the area under cultivation for accomplishing a total vegetative control. In some embodiments, the herbicidal composition is applied to a plant or to the area under cultivation for accomplishing a complete eradication of a weed,

In some embodiments, the herbicidal composition and/or the compound of the invention is substantially devoid of any humectant activity with respect to a herbicidal effect. In some embodiments, the herbicidal composition of the invention is devoid of a defoliant. In some embodiments, the herbicidal composition comprising any one of the compounds described herein is devoid of defoliating activity. In some embodiments, any one of the thiazole derivatives described herein and/or the herbicidal composition comprising same, is devoid of defoliating activity. In some embodiments, any one of the phenyl derivatives described herein and/or the herbicidal composition comprising same, is devoid of defoliating activity. Without being bound to any theory or mechanism, it is postulated that the compound induces growth inhibition or arrest by interaction with any possible biological pathway, thus the herbicidal activity is not induced by UV-visible light.

In some embodiments, there is a method for controlling the growth of undesirable vegetation by pre-emergence or post-emergence application of the composition, wherein controlling is as described herein. In one embodiment, therefore, the herbicidal composition of the invention is applied as a pre-emergent application. In a further embodiment, the herbicidal composition of the invention is applied as a post-emergent application. In some embodiments, the method of invention is for selectively controlling the growth of undesirable vegetation (e.g. a weed). In some embodiments, the herbicidal composition of the invention is substantially ineffective with respect to reducing the growth of crops.

In some embodiments, the herbicidal composition is applied to the soil using methods known in the art. These include but are not limited to: (a) drip irrigation or chemigation; (b) soil incorporation; (c) seed treatment.

In some embodiments, the herbicidal composition is applied to plants. In some embodiments, the composition is applied to plant parts. In some embodiments, the plant or plant part may be pre-harvest (rooted in the soil or hydroponics, open field, greenhouse etc.) or post-harvest. In some embodiments, the composition is applied to desired and undesired wild plants or crop plants (including naturally occurring crop plants). In some embodiments, the composition is applied to one or more plant parts selected from, but not limited to: shoot, leaf, flower, root, leaves, needles, stalks, stems, flowers, fruit bodies, seeds, roots, harvested material, vegetative and generative propagation material tubers, cuttings, offshoots, rhizomes and all parts and organs of plants above and below the ground.

In some embodiments, the herbicidal composition is exposed to the weed, soil, plant or part thereof. By “exposing” it is meant to refer to contacting directly or, in some embodiments, allowing the composition to act on their surroundings, habitat or storage space by, for example, immersion, coating, dipping, spraying, evaporation, fogging, scattering, painting on, or by injecting.

In some embodiments, the herbicidal composition of the invention is devoid of any additional agriculturally active substance such as e.g., nematicides, fungicides, insecticides, or bactericides known in the art. In some embodiments, the herbicidal composition of the invention comprises any one of the compounds of the invention as the active compound. In some embodiments, the herbicidal composition of the invention comprises any one of the compounds of the invention as the only active compound and is devoid of an additional agriculturally active compound.

In some embodiments, the herbicidal composition of the invention has at least 5 times, at least 10 times, at least 15 times, at least 20 times, at least 30 times, at least 40 times, at least 50 times, at least 80 times, at least 100 times, at least 200 times, at least 300 times, at least 400 times, at least 500 times, at least 700 times, at least 1000 times, at least 10,000 times, at least 50,000 times, at least 100,000 times lower minimum inhibitory concentration (MIC) for the weeds as compared to crops.

In some embodiments, the herbicidal composition of the invention applied at the herbicidally effective amount reduces up to 20%, up to 15%, up to 10%, up to 8%, up to 5%, up to 3%, up to 1% growth of a crop. In some embodiments, the effective amount is the herbicidally effective amount.

In some embodiments, the herbicidally effective amount for inhibiting weed growth is in the range of 0.1-50, 0.1-200, 0.1-300, 0.1-400, 0.1-500, 0.1-600, 0.1-700, 0.1-800, 0.1-1000, 0.1-1500, 0.1-2000, 0.1-2500, 0.1-3000, 0.1-5000, 0.2-50, 0.2-200, 0.2-300, 0.2-400, 0.2-500, 0.2-600, 0.2-700, 0.2-800, 0.2-1000, 0.2-1500, 0.2-2000, 0.2-2500, 0.2-3000, 0.2-5000, 0.5-50, 0.5-200, 0.5-300, 0.5-400, 0.5-500, 0.5-600, 0.5-700, 0.5-800, 0.5-1000, 0.5-1500, 0.5-2000, 0.5-2500, 0.5-3000, 0.5-5000, 1-50, 1-200, 1-300, 1-400, 1-500, 1-600, 1-700, 1-800, 1-1000, 1-1500, 1-2000, 1-2500, 1-3000, 1-5000, 2-50, 2-200, 2-300, 2-400, 2-500, 2-600, 2-700, 2-800, 2-1000, 2-1500, 2-2000, 2-2500, 2-3000, 2-5000, 5-50, 5-200, 5-300, 5-400, 5-500, 5-600, 5-700, 5-800, 5-1000, 5-1500, 5-2000, 5-2500, 5-3000, 5-5000, 25-50, 25-200, 25-300, 25-400, 25-500, 25-600, 25-700, 25-800, 25-1000, 25-1500, 25-2000, 25-2500, 25-3000, 25-5000, 50-200, 50-300, 50-400, 50-500, 50-600, 50-700, 50-800, 50-1000, 50-1500, 50-2000, 50-2500, 50-3000, or 50-5000 ppm including any range or value therebetween, of any one of the compound of the invention within the herbicidal composition. In some embodiments, the herbicidally effective amount of any one of the compounds of the invention within the herbicidal composition for inhibiting weed growth is in the range between 0.01 and 50%, between 0.01 and 0.05%, between 0.05 and 0.1%, between 0.1 and 0.5%, between 0.5 and 0.7%, between 0.7 and 1%, between 1 and 3%, between 3 and 5%, between 5 and 7%, between 7 and 10%, between 10 and 15%, between 15 and 20%, between 20 and 30%, between 30 and 50%, including any range or value therebetween.

In some embodiments, the method comprises applying the herbicidal composition of the invention at an effective dose from 10 to 5000 g/dunam, from 10 to 50 g/dunam, from 50 to 100 g/dunam, from 100 to 200 g/dunam, from 200 to 500 g/dunam, from 500 to 600 g/dunam, from 600 to 700 g/dunam, from 700 to 900 g/dunam, from 900 to 1000 g/dunam, from 1000 to 1500 g/dunam, from 1500 to 2000 g/dunam, from 2000 to 3000 g/dunam, from 3000 to 4000 g/dunam, from 4000 to 5000 g/dunam, including any range or value therebetween, wherein the effective dose is sufficient for controlling weeds.

In some embodiments, the effective dose of the compound for controlling weeds is at least 10 g/dunam, at least 50 g/dunam, at least 100 g/dunam, at least 200 g/dunam, at least 300 g/dunam, at least 400 g/dunam, at least 400 g/dunam, at least 500 g/dunam, at least 600 g/dunam, at least 700 g/dunam, at least 800 g/dunam, at least 1000 g/dunam, at least 1500 g/dunam, at least 1800 g/dunam, at least 2000 g/dunam, at least 2200 g/dunam, at least 2400 g/dunam, at least 2600 g/dunam, at least 2800 g/dunam, at least 3000 g/dunam, including any range or value therebetween.

In some embodiments, applying the herbicidal composition of the invention can significantly reduce the levels (e.g., amount, concentration) of a herbicide when applied together with the herbicidal composition of the invention.

In some embodiments, the compounds of the present invention will exert a dual and possibly synergistic herbicidal activity in combination with any another herbicidal active substance.

As used herein, the term “controlling” in the context of herbicides, indicates that the growth rate of weeds is reduced or even completely inhibited in a given time. In some embodiments, the term “reducing”, or any grammatical derivative thereof, indicates at least 20%, 30%, 40%, 50%, 60%, 70%, 80%, 90%, 95%, 97%, 99% including any value therebetween, reduction of the growth of weeds in a comparable situation lacking the presence of the disclosed compounds or a composition of matter containing same.

In some embodiments, the term “completely inhibited”, or any grammatical derivative thereof, refers to 100% arrest of growth in a given time as compared to the growth in that given time of the weed not being exposed to the treatment as described herein.

In some embodiments, the method of the invention is for selectively controlling the growth of a weed selected from Amaranthus (e.g. Amaranthus palmeri), Lolium (e.g. Lolium rigidum), Sinapis, Setaria, Echinochloa or any combination thereof.

It will be recognized that these embodiments are susceptible to various modifications and alternative forms well known to those of skill in the art.

### Herbicidal Composition

According to an aspect of the invention there is provided a herbicidal composition, comprising one or more compounds as described herein, and an agriculturally acceptable carrier. In some embodiments, the herbicidal composition comprising a herbicidally effective amount of one or more compounds as described herein, and an agriculturally acceptable carrier. In some embodiments, the herbicidal composition further comprises an agriculturally accepted salt of the compound. In some embodiments, provided herein an agricultural composition comprising any one of the compounds of the invention.

In some embodiments, the herbicidal composition comprises a compound at a concentration of 0.1 to 500 mg/ml. In some embodiments, the herbicidal composition comprises a compound at a concentration of 0.1 to 1 mg/ml. In some embodiments, the herbicidal composition comprises a compound at a concentration of 1 to 10 mg/ml. In some embodiments, the herbicidal composition comprises a compound at a concentration of 10 to 20 mg/ml. In some embodiments, the herbicidal composition comprises a compound at a concentration of 20 to 30 mg/ml. In some embodiments, the herbicidal composition comprises a compound at a concentration of 30 to 40 mg/ml. In some embodiments, the herbicidal composition comprises a compound at a concentration of 40 to 50 mg/ml. In some embodiments, the herbicidal composition comprises a compound at a concentration of 50 to 100 mg/ml. In some embodiments, the herbicidal composition comprises a compound at a concentration of 100 to 200 mg/ml. In some embodiments, the herbicidal composition comprises a compound at a concentration of 200 to 300 mg/ml. In some embodiments, the herbicidal composition comprises a compound at a concentration of 300 to 500 mg/ml.

In some embodiments, the w/w concentration (i.e. herbicidally effective amount) of any one of the compounds of the invention within the herbicidal composition is between 0.01 and 50%, between 0.01 and 0.05%, between 0.05 and 0.1%, between 0.1 and 0.5%, between 0.5 and 0.7%, between 0.7 and 1%, between 1 and 3%, between 3 and 5%, between 5 and 7%, between 7 and 10%, between 10 and 15%, between 15 and 20%, between 20 and 30%, between 30 and 50%, including any range or value therebetween.

In some embodiments, the agricultural carrier is a soil or a plant growth medium. In some embodiments, the agricultural carrier is selected from the group consisting of: a fertilizer, a plant-based oil, and a humectant, or any combination thereof.

In some embodiments, the w/w concentration of the agricultural carrier with the herbicidal composition is between 0.1 and 95%, between 0.1 and 0.5%, between 0.5 and 1%, between 1 and 5%, between 5 and 10%, between 10 and 15%, between 15 and 20%, between 20 and 30%, between 30 and 40%, between 40 and 50%, between 50 and 60%, between 60 and 70%, between 80 and 90%, between 90 and 95%, including any range or value therebetween.

In some embodiments, the agricultural carrier is a solid carrier. Non-limiting examples of solid carriers include but are not limited to: mineral carriers (e.g. kaolin clay, pyrophyllite, bentonite, montmorillonite, diatomaceous earth, acid white soil, vermiculite, pearlite, loam, and silica (e.g. Sipernat), inorganic salts (e.g. ammonium sulfate, ammonium phosphate, ammonium nitrate, urea, ammonium chloride, and calcium carbonate), alginate, vermiculite, seed cases, other plant and animal products, or any combination thereof including a granule, a pellets, and a suspension.

In some embodiments, the w/w concentration of the solid carrier with the herbicidal composition is between 0.1 and 95%, between 0.1 and 0.5%, between 0.5 and 1%, between 1 and 5%, between 5 and 10%, between 5 and 7%, between 7 and 10%, between 10 and 15%, between 15 and 20%, between 20 and 30%, between 30 and 40%, between 40 and 50%, between 50 and 60%, between 60 and 70%, between 80 and 90%, between 90 and 95%, including any range or value therebetween.

In some embodiments, the solid carrier comprises a plurality of solid carriers.

Non-limiting examples of liquid carriers include but are not limited to: soybean oil and cottonseed oil, glycerol, ethylene glycol, polyethylene glycol, propylene glycol, polypropylene glycol, or any combination thereof.

In some embodiments, the agricultural carrier comprises a mixture of any one of the aforementioned ingredients, such as pesta (flour and kaolin clay), agar or flour-based pellet in loam, sand, and clay.

In some embodiments, the herbicidal composition comprises a formulation. Non-limiting examples of formulations include but are not limited to: emulsions, wettable powders, suspensions, powders, dusts, pastes, soluble powders, granules, suspension-emulsion concentrates, natural and synthetic substances impregnated with active compound, very fine capsules in polymeric substances and in coating compositions for seed, and ULV formulations.

These formulations are produced in known manner, for example by mixing the active compounds with extenders, such as liquid solvents and/or solid carriers, and/or wetting agents optionally with the use of surface-active agents (e.g. is emulsifying agents, dispersing agents or dispersants, and foam-forming agents). Wetting agents are well-known in the art, comprising inter alia trisiloxane surfactants (Breakthru), non-ionic and cationic wetting agents.

In some embodiments, the herbicidal composition in a from of WP comprises a dispersant, a wetting agent, and a carrier (e.g. a solid carrier).

In some embodiments, the agricultural carrier comprises a dispersant. Various dispersants are well-known in the art, comprising inter alia Supragil, Ufoxan, a copolymer of benzylmethacrylate, acrylic acid and 2-acrylamido-2-methyl propane sulfonic acid, and other ionic and non-ionic polymeric dispersants known in the art.

In some embodiments, the formulation or the herbicidal composition of the invention further comprises an additive. Non-limiting examples of additives including but are not limited to: sticking agents, spreading agents, surfactants, synergists, penetrants, compatibility agents, buffers, acidifiers, defoaming agents, thickeners, and drift retardants or any combination thereof.

In some embodiments, the w/w concentration of the additive within the herbicidal composition is between 0.1 and 95%, between 0.1 and 0.5%, between 0.5 and 1%, between 1 and 5%, between 5 and 10%, between 10 and 15%, between 15 and 20%, between 20 and 30%, between 30 and 40%, between 40 and 50%, between 50 and 60%, between 60 and 70%, between 80 and 90%, between 90 and 95%, including any range or value therebetween.

In some embodiments, the formulation comprises a tackifier or adherent. Such agents are useful for combining the compound of the invention with carriers to yield a coating composition. Such compositions may aid to maintain contact between the compound of the invention or a composition containing thereof, and a weed.

In one embodiment, an adherent is selected from the group consisting of: alginate, a gum, a starch, a lecithin, formononetin, polyvinyl alcohol, alkali formononetinate, hesperetin, polyvinyl acetate, a cephalin, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and a polyoxyethylene-polyoxybutylene block copolymer. Other examples of adherent compositions that is used in the synthetic preparation include those described in EP 0818135, CA 1229497, WO 2013090628, EP 0192342, WO 2008103422 and CA 1041788.

In some embodiments, water or an aqueous solution is used as an extender. In other embodiments, organic solvents are used as auxiliary solvents. Exemplary auxiliary solvents are described in the Examples section. In some embodiments, the herbicidal composition comprises an aqueous solution and/or an organic liquid solvent.

Non-limiting examples of suitable liquid solvents include but are not limited to: xylene, ethylene glycol, propylene glycol, toluene or alkyl naphthalenes, chlorobenzenes, chloroethylenes, aliphatic hydrocarbons, such as cyclohexane or paraffins, mineral and vegetable oils, alcohols, such as butanol or glycol as well as their ethers and esters (e.g. ethyl lactate), ketones, such as acetone, methyl ethyl ketone, pyridine, methyl isobutyl ketone or cyclohexanone, strongly polar solvents, such as dimethylformamide (DMF) and dimethylsulfoxide (DMSO), as well as Water.

Non-limiting examples of suitable emulsifying and foam-forming agents include but are not limited to: non-ionic and anionic emulsifiers, such as polyoxyethylene-fatty acid esters, polyoxyethylene-fatty alcohol ethers, for example alkylaryl polyglycol ethers, alkylsulfonates, alkylsulfates, arylsulfonates as well as albumin hydrolyzation products.

Non-limiting examples of suitable dispersing agents include but are not limited to: lignin sulfite waste liquors and methylcellulose. Adhesives such as carboxymethyl cellulose and natural and synthetic polymers in the form of powders, granules or lattices, such as gum arabic, polyvinyl alcohol and polyvinyl acetate, as well as natural phospholipids, such as cephalins and lecithins, and synthetic phospholipids, is used in the formulations. Further additives can be mineral and vegetable oils.

Non-limiting examples of surfactants include nitrogen-surfactant blends such as Prefer 28 (Cenex), Surf-N (US), Inhance (Brandt), P-28 (Wilfarm) and Patrol (Helena); esterified seed oils include Sun-It II (AmCy), MSO (UAP), Scoil (Agsco), Hasten (Wilfarm) and Mes-100 (Drexel); and organo-silicone surfactants include Silwet L77 (UAP), Silikin (Terra), Dyne-Amic (Helena), Kinetic (Helena), Sylgard 309 (Wilbur-Ellis) and Century (Precision). In one embodiment, the surfactant is present at a concentration of between 0.01% v/v to 10% v/v. In another embodiment, the surfactant is present at a concentration of between 0.1% v/v to 1% v/v. In some embodiments, the surfactant is present within the herbicidal composition of the invention at a concentration between 0.1% and 1% w/w, between 1% and 3% w/w, between 3% and 5% w/w, between 5% and 10% w/w, between 10% and 15% w/w, between 15% and 20% w/w, between 20% and 30% w/w, between 30% and 40% w/w, between 40% and 50% w/w including any range therebetween.

The term “anionic surfactant” refers to any surfactant containing an anionic functional group including sulfate, sulfonate, phosphate, and carboxylates. Non-limiting examples of anionic surfactants include, but are not limited to, alkylbenzenesulfonate, ammonium lauryl sulfate, sodium lauryl sulfate (sodium dodecyl sulfate, SLS, or SDS), sodium laureth sulfate (sodium lauryl ether sulfate or SLES), sodium myreth sulfate, dioctyl sodium sulfosuccinate (Docusate), perfluorooctanesulfonate (PFOS), perfluorobutanesulfonate, alkyl-aryl ether phosphates, alkyl ether phosphates, sodium stearate, sodium lauroyl sarcosinate, perfluorononanoate, and perfluorooctanoate (PFOA or PFO). In some embodiments, the anionic surfactant is a linear alkylbenzenesulfonate.

In some embodiments, the herbicidal composition comprises an anionic surfactant, such as a linear alkylbenzenesulfonate, at an amount of at least 2%, at least 3%, at least 4%, at least 5%, at least 6%, at least 7%, at least 8%, at least 9%, at least 10%, or any value or range therebetween. In some embodiments, the composition comprises an anionic surfactant, such as a linear alkylbenzenesulfonate, at an amount ranging from 2-7%, 2-8%, 2-10%, 3-9%, 5-10%, 4-8%, 5-9%, 6-10%, 2-6%, or 8-10%. Each possibility represents a separate embodiment of the invention.

The term “nonionic surfactant” refers to any surfactant having covalently linked oxygen-containing hydrophilic groups, which are bonded to hydrophobic parent structures. Non-limiting examples of nonionic surfactants include, but are not limited to, ethoxylated castor oil, narrow-range ethoxylate, octaethylene glycol monododecyl ether, pentaethylene glycol monododecyl ether, nonoxynols, triton X-100, polyethoxylated tallow amine, cocamide monoethanolamine, cocamide diethanolamine, poloxamers, glycerol monostearate, glycerol monolaurate, sorbitan monolaurate, sorbitan monostearate, sorbitan tristearate, tween (e.g., tween 20, 40, 60, and 80), decyl glucoside, lauryl glucoside, octyl glucoside, lauryldimethylamine oxide, dimethyl sulfoxide, phosphine oxide, and others. In some embodiments, the nonionic surfactant is an ethoxylated castor oil.

In some embodiments, the herbicidal composition or the composition comprises a nonionic surfactant, such as ethoxylated castor oil, at an amount of at least 5%, at least 6%, at least 7%, at least 8%, at least 9%, at least 10%, at least 11%, at least 12%, at least 13%, at least 14%, at least 15%, or any value or range therebetween. In some embodiments, the composition comprises a nonionic surfactant, such as an ethoxylated castor oil, at an amount ranging from 5-10%, 7-14%, 9-15%, 8-12%, 5-15%, 6-13%, 7-11%, 8-15%, 9-13%, or 10-15%. Each possibility represents a separate embodiment of the invention.

The disclosed herbicidal compositions set forth above may be formulated in any manner. Non-limiting formulation examples include but are not limited to Dried grains, Emulsifiable concentrates (EC), Wettable powders (WP), Soluble liquids (SL), Aerosols, Ultra-low volume concentrate solutions (ULV), Soluble powders (SP), Microencapsulation, Water dispersed granules (WDG), Flowables (FL), Microemulsions (ME), Nano-emulsions (NE), etc. In any formulation described herein, percent of the active ingredient is well within the skills of the artisan e.g., within a range of 0.01% to 99.99%.

In some embodiments, the herbicidal composition is in the form of WP. Exemplary WP composition is described in the Examples section.

In some embodiments, the herbicidal composition is in the form of, but not limited to, a liquid, gel, solid or biofumigant. In some embodiments, the composition comprises a surfactant to be used for the purpose of emulsification, dispersion, wetting, spreading, integration, disintegration control, stabilization of active ingredients, and improvement of fluidity or rust inhibition. In some embodiments, the surfactant is a non-phytotoxic non-ionic surfactant. In one embodiment, the carrier is a perlite particle. Solid compositions can be prepared by dispersing the compound of the invention in and on an appropriately divided solid carrier, such as peat, wheat, bran, vermiculite, clay, talc, bentonite, diatomaceous earth, fuller's earth, pasteurized soil, and the like. When such formulations are used as wettable powders, biologically compatible dispersing agents such as non-ionic, anionic, amphoteric, or cationic dispersing and emulsifying agents can be used.

In some embodiments, the herbicidal composition of the invention (e.g. in a form of WP or in a form of a suspension) comprises the compound of the invention having a particle size characterized by a median diameter of less than 30 um, of less than 25 um, of less than 20 um, of less than 15 um, of less than 8 um, of less than 10 um, of less than 7 um, of less than 6 um, of less than 5 um, of less than 4 um, including any range between.

In some embodiments, the particle size of the compound is characterized by a span of less than 3, less than 2.8, less than 2.7, less than 2.6, less than 2.5, including any range between.

In some embodiments, the herbicidal composition of the invention (e.g. in a form of WP or in a form of a suspension) comprises the compound of the invention in a form of a particle characterized by a specific surface area greater than 300 m²/kg, greater than 500 m²/kg, greater than 700 m²/kg, greater than 1000 m²/kg, greater than 1500 m²/kg, greater than 1700 m²/kg, greater than 2000 m²/kg, greater than 2500 m²/kg, including any range between.

As shown in the Examples section, a grinded particles having D(50) of about 4 um and a specific surface area of about 2600 m²/kg has an improved solubility or dispersivity either alone or as a part of a WP, within a solvent (e.g. DMSO, Ethyl lactate, an aqueous solution).

In some embodiments, the herbicidal composition (e.g. in a form of an emulsion or a dispersion) has a pH below 8, below 7, below 6, below 5, below 4, below 3, below 2, including any range between. In some embodiments, the herbicidal composition characterized by a basic pH (e.g. above 8) has a reduced biological activity. According to the experimental data, aqueous compositions comprising about 2% ammonium hydroxide solution exhibited a reduced biological activity.

In some embodiments, the herbicidal composition is a field ready spray or a tank mix.

The compounds described hereinabove may be applied or otherwise utilized either as is, or as an agriculturally acceptable salt, enantiomer, diastereomer, solvate, or hydrate.

Non limiting examples of agriculturally acceptable salts include but are not limited to: cations derived from alkali or alkaline earth metals (e.g. sodium, potassium, magnesium), cations derived from ammonia and amines (e.g. ammonium, diethylammonium, ethanolammonium, isopropylammonium) and trimethylsulfonium salts.

In some embodiments, the compounds described herein are chiral compounds (i.e. possess an asymmetric carbon atom). In some embodiments, diastereomers, geometric isomers and individual isomers are encompassed within the scope of the present invention. In some embodiments, a chiral compound described herein is in form of a racemic mixture. In some embodiments, a chiral compound is in form of a single enantiomer, with an asymmetric carbon atom having the R configuration. In some embodiments, a chiral compound is in form of a single enantiomer, with an asymmetric carbon atom having the S configuration.

In some embodiments, a chiral compound is in form of a single enantiomer with enantiomeric purity of more than 70%. In some embodiments, a chiral compound is in form of a single enantiomer with enantiomeric purity of more than 80%. In some embodiments, a chiral compound is in form of a single enantiomer with enantiomeric purity of more than 90%. In some embodiments, a chiral compound is in form of a single enantiomer with enantiomeric purity of more than 95%.

In some embodiments, the compounds described herein can exist in unsolvated form as well as in solvated form, including hydrated form. In general, the solvated form is equivalent to the unsolvated form and is encompassed within the scope of the present invention. Certain compounds of the present invention may exist in multiple crystalline or amorphous forms. In general, all physical forms are equivalent for the uses contemplated by the present invention and are intended to be within the scope of the present invention.

The term “solvate” refers to a complex of variable stoichiometry (e.g., di-, tri-, tetra-, penta-, hexa-, and so on), which is formed by a solute (the conjugate described herein) and a solvent, whereby the solvent does not interfere with the biological activity of the solute. Suitable solvents include, for example, ethanol, acetic acid and the like.

The term “hydrate” refers to a solvate, as defined hereinabove, where the solvent is water.

### Definitions

As used herein, the term “alkyl” describes an aliphatic hydrocarbon including straight chain and branched chain groups. Preferably, the alkyl group has 20 or less main-chain carbons. The alkyl is substituted or unsubstituted, as defined herein.

The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e. rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e. rings which share adjacent pairs of carbon atoms) groups having a completely conjugated pi-electron system. The aryl group may be substituted or unsubstituted, as indicated herein.

The term “alkoxy” describes both an O-alkyl and an —O-cycloalkyl group, as defined herein.

The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, alkoxy, nitro, amino, hydroxyl, thiol, thioalkoxy, thiohydroxy, carboxy, amide, aryl and aryloxy, depending on the substituted group and its position in the molecule. Additional substituents are also contemplated.

The term “haloalkoxy” describes an alkoxy group as defined herein, further substituted by one or more halide(s).

The term “hydroxyl” or “hydroxy” describes a —OH group.

The term “mercapto” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amino” describes a —NR′R″ group, with R′ and R″ as described herein.

The term “heteroalicyclic” or “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofurane, tetrahydropyrane, morpholino and the like.

The term “carboxy” or “carboxylate” describes a —C(O)OR′ group, where R′ is hydrogen, alkyl, cycloalkyl, alkenyl, aryl, heteroaryl (bonded through a ring carbon) or heteroalicyclic (bonded through a ring carbon) as defined herein.

The term “carbonyl” or “keto” describes a —C(O)R′ group, where R′ is as defined hereinabove.

The above-terms also encompass thio-derivatives thereof (thiocarboxy and thiocarbonyl).

The term “thiocarbonyl” describes a —C(S)R′ group, where R′ is as defined hereinabove.

A “thiocarboxy” group describes a —C(S)OR′ group, where R′ is as defined herein.

A “sulfinyl” group describes an —S(O)R′ group, where R′ is as defined herein.

A “sulfonyl” or “sulfonate” group describes an —S(O)₃R′ group, where R′ is as defined herein.

A “sulfone” group describes an —S(O)₂R′ group, where R′ is as defined herein.

A “carbamyl” or “carbamate” group describes an —OC(O)NR′R″ group, where R′ is as defined herein and R″ is as defined for R′.

A “nitro” group refers to a —NO₂ group.

The term “amide” as used herein encompasses C-amide and N-amide.

The term “C-amide” describes a —C(O)NR′R″ end group or a —C(O)NR′-linking group, as these phrases are defined hereinabove, where R′ and R″ are as defined herein.

The term “N-amide” describes a —NR″C(O)R′ end group or a —NR′C(O)- linking group, as these phrases are defined hereinabove, where R′ and R″ are as defined herein.

The term “carboxylic acid derivative” as used herein encompasses carboxy, amide, anhydride, carbonate ester, a carbamide, a thioester, and carbamate. In some embodiments, carboxylic acid derivative is devoid of carboxy group. In some embodiments, the attachment point of the carboxylic acid derivative to the molecule is via carbon or via oxygen.

A “cyano” or “nitrile” group refers to a —CN group.

The term “azo” or “diazo” describes an —N═NR′ end group or an —N═N- linking group, as these phrases are defined hereinabove, with R′ as defined hereinabove.

The term “guanidine” describes a —R′NC(N)NR″R″′ end group or a —R′NC(N) NR″- linking group, as these phrases are defined hereinabove, where R′, R″ and R′″ are as defined herein.

As used herein, the term “azide” refers to a —N₃ group.

The term “sulfonamide” refers to a —S(O)₂NR′R″ group, with R′ and R″ as defined herein.

The term “phosphonyl” or “phosphonate” describes an —OP(O)-(OR′)₂ group, with R′ as defined hereinabove.

The term “phosphinyl” describes a —PR′R″ group, with R′ and R″ as defined hereinabove.

The term “alkylaryl” describes an alkyl, as defined herein, which substituted by an aryl, as described herein. An exemplary alkylaryl is benzyl.

The term “heteroaryl” describes a monocyclic or fused ring (i.e. rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazole, pyridine, pyrrole, oxazole, indole, purine and the like.

The term “halide”, or “halo” describes fluorine, chlorine, bromine or iodine.

The term “haloalkyl” describes an alkyl group as defined above, further substituted by one or more halide(s).

The term “vinyl” refers to a —CH═CH₂ group.

The term “allyl” refers to a —CH₂—CH═CH₂ group.

The term “thioalkyl” or “mercaptoalkyl” describes an alkyl group as defined above, further substituted by one or more mercapto group(s). In some embodiments, the attachment point of the thioalkyl to the molecule is via the thiol or via the methylene.

The term “alkylhydroxy” describes an alkyl group as defined above, further substituted by one or more hydroxy group(s). In some embodiments, the attachment point of the alkylhydroxy to the molecule is via the hydroxy or via the methylene.

The term “alkylamide” describes an alkyl group as defined above, further substituted by one or more amide group(s). In some embodiments, the attachment point of the alkylamide to the molecule is via the amine or via the methylene.

The term “alkylamine” or “alkylamino” describes an alkyl group as defined above, further substituted by one or more amine group(s). In some embodiments, the attachment point of the alkylamine to the molecule is via the amine or via the methylene.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Paper Germination

### Materials

Each compound was dissolved in DMSO and then in distilled water to obtain a 0.0125-0.5 mg/ml solution with 0.5% DMSO. 0.5% DMSO solution in water was used as a negative control. As a positive control, 0.0125-0.5 mg/ml Galigan solution was used.

### Experimental Procedure

A paper towel was placed in each box as bedding for seeds. Each box was soaked with 8 ml of the solutions on its paper. 13 seeds were placed on the wet paper, and the box was sealed and incubated under conditions provided below.

Amaranthus palmeri—first 2 days under dark conditions. Plants were first incubated at 25° C. for 8 hr, then at 30° C. for 16 hr. Afterwards, plants were incubated at 25° C. for 8 hr in dark, followed by 16 hr at 21° C. in light.

Lolium rigidum—first 4 days under dark conditions. Plants were first incubated at 21° C. for 8 hr, then at 28° C. for 16 hr. Afterwards, plants were incubated at 25° C. for 8 hr in dark, followed by 16 hr at 28° C. in light.

Germination was assessed and scored after 3-10 days. Scoring scale: 0—complete germination inhibition, 100—no effect.

Phenyl derivatives: the compounds (Pubchem CID Numbers: 81909, 83611, 4059, 12384822, 118268726, 22274775, 63365124, 47001312, 2758572, 22688812, 45792259, 2838813, 6951554, 7134, 17839219, 22645935, 53403656, 11087964, 1504047, 578887, 58046356, 69705) reduced germination of Amaranthus palmeri or both Amaranthus palmeri and Lolium rigidum, by at least 70% (score=0-30).

The compounds (Pubchem CID Numbers: 4775, 997, 21572647) were substantially less effective.

Thiazole derivatives: the compounds (Pubchem CID Numbers: 8486, 3778536, 15058919, 12542663, 3770038, 219073, 321577, 288329, 3145071, 3155137, 323571, 324461, 4070530, 3136329, 41684, 4467314, 3616815, 121536923, 102770384, 541661, 77887, 1254266, 34164146, 288329, 219073) reduced (score=0-30) germination of Amaranthus palmeri. The compound 8486 significantly reduced germination of both Amaranthus palmeri and Lolium rigidum.

The compounds (Pubchem CID Numbers: 12574, 327544, 16192542, 736488) were substantially ineffective.

### Example 2

### Preemergence

### Materials:

Compounds were dissolved in DMSO and then in distilled water to get 0.5-2 mg/ml solution with 0.5-2% DMSO. 0.5-2% DMSO solution in water was used as a negative control. As a positive control, 0.2 mg/ml Galigan solution was used.

### Experimental Procedure:

Flowerpots were filled with 30 g of soil, and 4-5 seeds were sowed in each flowerpot. Each treatment contained 3 flowerpots. Each flowerpot was sprayed with 1.5 ml of the dissolved compound. Soil was let dry for about 1 hour at room temperature, and then each flowerpot was sub-irrigated with 40-50 ml water and incubated under conditions provided below.

Amaranthus palmeri was incubated at 25° C. for 8 hr in dark, followed by 16 hr at 30° C. in light.

Lolium rigidum was incubated at 21° C. for 8 hr in dark, followed by 16 hr at 21° C. in light.

Germination was assessed and scored after 3-8 days. Scoring scale: 0—complete germination inhibition, 100—no effect.

Phenyl derivatives: compounds of the invention (e.g., Pubchem CID Numbers: 81909, 47001312, 22688812, 7134, 17839219, 53403656, 11087964) showed substantial activity (score=0-30) in preventing germination of Amaranthus palmeri. Additional compounds (e.g., Pubchem CID Numbers: 1504047, 578887, 69705) showed solid activity (score=35-60) in preventing germination of Amaranthus palmeri.

Furthermore, compounds of the invention (e.g., Pubchem CID Numbers: 17839219, 53403656, 81909, 47001312, 7134, 11087964) showed a superior activity (score=0-21) in preventing germination of Amaranthus palmeri at a concentration of 2 mg/ml. Further, compounds of the invention (e.g., Pubchem CID Numbers: 53403656, 11087964) showed superior activity (score=5-10) in preventing germination of Amaranthus palmeri at a concentration of 0.5 mg/ml.

The following compound: Pubchem CID Numbers: 4775, 21572647, 22274775, 2758572, and 118268726 were substantially ineffective in this experiment.

Thiazole derivatives: compounds of the invention (e.g., Pubchem CID Number: 541661, 77887, 12542663) showed substantial activity (score=0-30) in preventing germination of Amaranthus palmeri. Additional compounds (e.g., Pubchem CID Number: 4164146, 288329, 219073) showed moderate activity (score=40-66) in preventing germination of Amaranthus palmeri.

Furthermore, compounds of the invention (e.g., Pubchem CID Numbers: 8486, 541661) showed a superior activity (score=10-50) in preventing germination of Amaranthus palmeri and Lolium rigidum at a concentration of 2 mg/ml. Further, the following compounds: Pubchem CID Numbers: 541661, and 125426631 showed substantial activity (score=0-30) in preventing germination of Solanum nigrum and Lactuca sativa.

Furthermore, the following compounds: Pubchem CID Numbers: 541661, and 12542663 at a concentration described hereinabove, didn't affect substantially Zea mays and Triticum vulgare showing selective herbicidal activity against different weed species.

The following compounds: Pubchem CID Numbers: 12078, 11921, 122760, 77888, 74895, 12216438, 16228937 were substantially ineffective.

### Example 3

### Soaking Experiment

### Materials:

The compounds were dissolved in DMSO and then in distilled water to obtain a 1 mg/ml solution with 0.25%DMSO. For negative control 0.25% DMSO in water was used. For positive control, 1 mg/ml Roundup solution was used.

### Experimental Conditions:

Compound solutions were used to soak 11-days old Amaranthus palmeri plants. Each treatment contained four plants. Each plant was soaked with 4 ml solution and with additional 4 ml from the same solution the next day. Plants were incubated at 8 hr 25° C. dark/16 hr 30° C. light cycles. Phytotoxicity was assessed and scored after 1-11 days. Scoring scale: 0—complete phytotoxic effect, 100—no effect.

Phenyl derivatives: the compound of Pubchem CID Number: 81909 exhibited extensive herbicidal activity in this experiment (score=0). The following compounds (Pubchem CID Numbers: 83611, 12384822) exhibited moderate herbicidal activity in this experiment.

Thiazole derivatives: the following compounds (Pubchem CID Number: 8486, 219073, 18211, 288329) exhibited extensive herbicidal activity (score=0-10) in this experiment.

### Example 4

### Foliar Experiment

### Materials:

Compounds were dissolved in DMSO and then in distilled water to get 2 mg/ml solution with 0.5-2% DMSO. Break-Thru surfactant was added to a final concentration of 0.05%. For negative control a solution of 0.5-2% DMSO and 0.05% Break-Thru in water was used. For positive control a solution of 2 mg/ml Roundup was used.

### Experimental Procedure:

1.5 ml of each compound solution were sprayed on the foliage of 8-9 Amaranthus palmeri plants, which were 11-12 days old at the day of the experiment. Plants were let dry for about 15 minutes at room conditions, and then incubated under conditions provided below. Incubation conditions: cycles of 8 hr at 25° C. in dark, following by 16 hr at 30° C. in light. Phytotoxicity was assessed and scored after 1 -8 days. Scoring scale: 0—complete phytotoxic effect, 100—no effect.

The compounds (Pubchem CID Number: 3155137, 4070530, 102770384, 43600, 7134, 47001312, 45792259) exhibited solid herbicidal activity, and the compounds (Pubchem CID Number: 8486, 219073) exhibited extensive herbicidal activity in this experiment.

The compounds of the invention (Pubchem CID Number: 2838813, 1504047) exhibited extensive herbicidal activity in this experiment.

TABLE 1
A table summarizing the herbicidal
activity of the compound (Pubchem
CID Number: 8486) against foliage
of different weed species in the
laboratory experiment.

| | Lab foliar |
|---|---|
| Plant | experiment |
| Amaranthus palmeri | 0 |
| Echinochloa colonum | 20 |
| Solanum nigrum | 5 |
| Setaria adhaerens | 10 |
| Abutilon theophrasti | 40 |
| Gossypium hirsutum | 70 |
| Lolium rigidum | 70 |
| Triticum vulgare | 90 |
| Sinapis alba | 80 |
| Lactuca sativa | 90 |

As shown in Table 1, the compound (Pubchem CID Number: 8486) demonstrated solid herbicidal activity against a broad range of weeds in this experiment.

### Example 5

### Field Foliar Experiment

### Materials:

6 g of each compound were dissolved in 15 ml DMSO and then 1.5 L distilled water and 1.5 ml Break-Thru surfactant were added, to get 4 mg/ml solution with 1% DMSO and 0.1% Break-Thru. Negative control—1% DMSO+0.1% Break-Thru. Positive control—3.6mg/ml Roundup (15 ml from the commercial product in 1.5 L distilled water).

### Experimental Conditions:

Plots were sprayed with a mechanical sprayer at a volume adjusted to 20 L/D, yielding 80 g/D dose (72g/D for Roundup treatment). Each treatment was sprayed on a 6 m² plot in four repeats. Phytotoxicity was assessed and scored after 2-4 weeks. Scoring scale: 0—complete phytotoxic effect, 100—no effect.

TABLE 2
A table summarizing the herbicidal
activity of the compound (Pubchem
CID Number: 8486) against different
weed species in the field experiment.

| | Field foliar |
|---|---|
| Plant | experiment |
| Solanum nigrum | 80 |
| Sonchus oleraceus | 10 |
| Melilotus sulcatus | 30 |
| Conyza bonariensis | 20 |
| Senecio vernalis | 0 |

As shown in Table 2, the compound (Pubchem CID Number: 8486) demonstrated solid herbicidal activity against a broad range of weeds in the field experiment.

### Example 6

### Net-House Soil Germination

### Materials:

18 g of each compound were dissolved in 12 ml DMSO and then 588 distilled water were added, to obtain 30 mg/ml solution with 2% DMSO. Negative control—2% DMSO. Positive control—3 mg/ml Galigan (7.5 ml from the commercial product in 592.5 ml distilled water).

### Experimental Conditions:

Flowerpots (300 ml volume each) were filled with soil, and 5-10 seeds were sowed in each flowerpot. Each treatment contained 5 flowerpots. Flowerpots were sprayed with a mechanical sprayer at a volume adjusted to 20 L/D, yielding 600 g/D dose (60 g/D for Galigan treatment). In some treatments, the pots were sprayed twice yielding 1,200 g/D dose. Soil was let dry for about 1 hour, and then the flowerpots were irrigated and grown in a net house. Phytotoxicity was assessed and scored after 2-4 weeks. Scoring scale: 0—complete phytotoxic effect, 100—no effect.

TABLE 3
A table summarizing the herbicidal activity of the
compound (Pubchem CID Number: 4059) against
different weed species in the net-house experiment.

| | | Dose | |
|---|---|---|---|
| | Plant | (g/dunam) | Score |
| Net house | Avena sativa | 600 | 100 |
| soil germination | | 1200 | 100 |
| experiment | Setaria verticillata | 600 | 30 |
| | | 1200 | 20 |
| | Lolium multiflorum | 600 | 95 |
| | | 1200 | 85 |
| | Amaranthus blitoides | 600 | 90 |
| | | 1200 | 40 |
| | Amaranthus palmeri | 600 | 20 |
| | | 1200 | 20 |
| | Echinochloa colonum | 600 | 40 |
| | | 1200 | 30 |
| | Sinapis arvensis | 600 | 35 |
| | | 1200 | 15 |
| | Xanthium strumarium | 600 | 100 |
| | | 1200 | 100 |

As shown in Table 3, the compound (Pubchem CID Number: 4059) demonstrated solid herbicidal activity against a broad range of weeds in this experiment. As represented by Table 3, the compound was ineffective with respect to Avena sativa, thus showing selectivity against weeds.

### Example 7

### Field Soil Germination

### Materials:

120 g of each compound were dissolved in 20 ml DMSO and then 4 L distilled water were added, to get 30 mg/ml solution with 0.5% DMSO. Negative control—0.5% DMSO. Positive control—3 mg/ml Galigan (7.5 ml from the commercial product in 592.5 ml distilled water).

### Experimental Conditions:

Plots were sprayed with a mechanical sprayer at a volume adjusted to 20 L/D, yielding 600 g/D dose (60 g/D for Galigan treatment). In some treatments, the pots were sprayed twice to yield 1,200 g/D dose and four times to yield 2,400 g/D. Each treatment was sprayed on a 20 ml plot. Soil was let dry for about 1 hour, and then irrigated at 5 ml/dunam rate. Phytotoxicity was assessed and scored after 2-7 weeks. Scoring scale: 0—complete phytotoxic effect, 100—no effect.

TABLE 4
A table summarizing the herbicidal activity of the
compound (Pubchem CID Number: 4059) against
different weed species in the field experiment.

| | | Dose | |
|---|---|---|---|
| | Plant | (g/dunam) | Score |
| Field soil | Zea mays | 600 | 100 |
| germination | | 1200 | 100 |
| experiment | | 2400 | 100 |
| | Citrullus lanatus | 600 | 0 |
| | | 1200 | 0 |
| | | 2400 | 0 |
| | Setaria adhaerens | 600 | 64 |
| | | 1200 | 21 |
| | | 2400 | 11 |
| | Solanum nigrum | 600 | 27 |
| | | 1200 | 13 |
| | | 2400 | 20 |
| | Amaranthus different | 600 | 40 |
| | species | 1200 | 0 |
| | | 2400 | 0 |
| | Sonchus oleraceus | 600 | 100 |
| | | 1200 | 50 |
| | | 2400 | 50 |
| | Vrbesina encelioides | 600 | 40 |
| | | 1200 | 0 |
| | | 2400 | 0 |
| | Cyperus rotundus | 600 | 40 |
| | | 1200 | 100 |
| | | 2400 | 120 |

As shown in Table 4, the compound (Pubchem CID Number: 4059) demonstrated solid herbicidal activity against a broad range of weeds in the field experiment. Furthermore, the compound didn't affect Zea mays, showing selective herbicidal activity against different weed species.

### Example 8

### Preemergence For Different Weeds and Crops

Compounds were dissolved in DMSO and then in distilled water to get 0.5-2 mg/ml solution with 0.5-1% DMSO. Negative control—0.5-1% DMSO.

Flowerpots were filled with 30 g of soil, each treatment contained three flowerpots. Each flowerpot was sprayed with 1.5 ml of the dissolved compound. Soil was let dry for about 1 hour at room conditions, and then each flowerpot was sub-irrigated with 40-50 ml water and incubated at controlled growth chambers. Germination was assessed and scored after 3-14 days. Scoring scale: 0—complete germination inhibition, 100—no effect.

The experimental conditions were as follows:

| | No. of | Growth |
|---|---|---|
| Plant | seeds/treatment | conditions |
| Amaranthus palmeri | 15 | 8 hr 25° C. dark/ |
| | | 16 hr 30° C. light |
| Solanum nigrum | 12 | 8 hr 25° C. dark/ |
| | | 16 hr 30° C. light |
| Abutilon theophrasti | 12 | 8 hr 25° C. dark/ |
| | | 16 hr 30° C. light |
| Lactuca sativa | 18 | 8 hr 25° C. dark/ |
| | | 16 hr 30° C. light |
| Sinapis alba | 18 | 8 hr 21° C. dark/ |
| | | 16 hr 21° C. light |
| Datura ferox | 15 | 8 hr 25° C. dark/ |
| | | 16 hr 30° C. light |
| Echinochloa colonum | 12 | 8 hr 25° C. dark/ |
| | | 16 hr 30° C. light |
| Setaria adhaerens | 15 | 8 hr 25° C. dark/ |
| | | 16 hr 30° C. light |
| Lolium rigidum | 15 | 8 hr 21° C. dark/ |
| | | 16 hr 21° C. light |
| Zea mays | 15 | 8 hr 25° C. dark/ |
| | | 16 hr 30° C. light |
| Triticum vulgare | 15 | 8 hr 21° C. dark/ |
| | | 16 hr 21° C. light |

Compounds (Pubchem CID Numbers: 81909, 11087964, 12542663, 541661) were tested in this experiment, demonstrating solid herbicidal activity against a broad range of weeds (Amaranthus palmeri, Solanum nigrum, Lactuca sativa). Additionally: compound (Pubchem CID Number 541661) demonstrated solid herbicidal activity against Lolium rigidum; compounds (Pubchem CID Number 541661, 81909, 11087964) demonstrated solid herbicidal activity against Sinapis alba, Setaria adhaerens; compounds (Pubchem CID Number 541661, 81909) demonstrated solid herbicidal activity against Datura ferox; compound (Pubchem CID Number 81909) demonstrated solid herbicidal activity against Abutilon theophrasti, Echinochloa colonum.

Furthermore, the tested compounds at a concentration described hereinabove, didn't affect substantially Zea mays and Triticum vulgare showing selective herbicidal activity against different weed species.

### Example 9

### Dissolution and Formulation Assay

Compounds (Pubchem CID Number: 4059, 8486, 81909) were dissolved in various auxiliary solvents and subsequently diluted with water. The dissolution was assessed and scored. Scoring scale (solubility grade): 0—complete dissolution, 10—no visible dissolution.

Table 5 shows dissolution of compound 4059.

| Concentration | | Solubility |
|---|---|---|
| (mg/ml) | Solvent | score |
| 30 | 0.5% DMSO | 5 |
| 30 | 2% DMSO | 5 |
| 30 | 2% DMSO | 5 |
| 30 | 2% DMSO | 5 |
| 15 | 3% DMSO | 10 |
| 16 | 4% DMSO | 10 |
| 30 | 4% DMSO | 0 |
| 30 | 6% DMSO | 8 |
| 4 | 2% Ethyl lactate | 10 |
| 8 | 2% Ethyl lactate | 10 |
| 16 | 2% Ethyl lactate | 6 |
| 15 | 3% Ethyl lactate | 10 |
| 8 | 4% Ethyl lactate | 10 |
| 16 | 4% Ethyl lactate | 10 |
| 16 | 6% Ethyl lactate | 10 |
| 30 | 6% Ethyl lactate | 10 |
| 30 | 8% Ethyl lactate | 10 |

Table 6 shows dissolution of compound 81909.

| Concentration | | Solubility |
|---|---|---|
| (mg/ml) | Solvent | score |
| 1 | 0.5% DMSO | 10 |
| 5 | 2% DMSO | 10 |
| 7.5 | 2% DMSO | 10 |
| 10 | 2% DMSO | 10 |
| 7.5 | 3% DMSO | 10 |
| 5 | 2% Ethyl lactate | 10 |
| 7.5 | 3% Ethyl lactate | 10 |
| 5 | 4% Ethyl lactate | 10 |
| 10 | 4% Ethyl lactate | 10 |
| 1 | 8% Ethyl lactate | 10 |
| 10 | 8% Ethyl lactate | 10 |
| 200 | 100% Ethyl lactate | 10 |
| 250 | 100% 150 solvent | 10 |

Table 7 shows the dissolution of compound 8486.

| Concentration | | Solubility | |
|---|---|---|---|
| (mg/ml) | Solvent | score | Comments |
| 4 | 1% DMSO | 3 | |
| 2 | 2% DMSO | 9 | |
| 4 | 5% Ethyl lactate | 0 | |
| 4 | 10% Ethyl lactate | 7 | |
| 6 | 20% Ethyl lactate | 10 | |
| 2 | 2% Pyridine | 10 | |
| 5 | acetic acid | 5 | |
| 4 | 15% Propylene glycol | 0 | |
| 2.5-7.5 | WP 1:1 | 10 | grinded |
| 2.5-7.5 | 2% DMSO, WP 1:1 | 10 | grinded |
| 4 | 30% Ethyl lactate | 10 | grinded |
| 4 | 30% Ethyl lactate, WP 1:1 | 10 | grinded |
| 6 | 30% Ethyl lactate, WP 1:1 | 10 | grinded |
| 1 | 0.002% NH₄OH | 8 | grinded |
| 1 | 0.02% NH₄OH | 10 | grinded |
| 2.0-8.0 | 2% NH₄OH | 10 | |

As exemplified hereinbelow, grinded compound 8486 exhibited an enhanced solubility, as compared to unprocessed compound. Hereinbelow are present particle size and surface area characteristics of the grinded and of the unprocessed compounds.

| Before grindinig, AS-486 partical | |
|---|---|
| size had the following partical | |
| size specifications: | |
| Span | 2.485 |
| Specific Surface Area | 200.0 m²/kg |
| Dv (10) | 14.6 μm |
| Dv (50) | 44.6 μm |
| Dv (90) | 125 μm |
| Dv (99) | 292 μm |
| Dv (100) | 583 μm |
| Volume Below (10) μm | 4.66% |
| Grinded AS-486 had the following | |
| partical size specifications: | |
| Span | 3.160 |
| Specific Surface Area | 2685 m²/kg |
| Dv (10) | 0.824 μm |
| Dv (50) | 3.95 μm |
| Dv (90) | 13.3 μm |
| Dv (99) | 27.0 μm |
| Dv (100) | 40.0 μm |
| Volume Below (10) μm | 83.11% |

Furthermore, the grinded compound has been used for the preparation of a wetting powder composition (WP). As exemplified hereinbelow, WP composition showed an enhanced aqueous solubility, compared to non-formulated compounds.

Hereinbelow is presented an exemplary WP composition:

| Compound | Concentration | Manufacturer |
|---|---|---|
| Supragil MNS/90 | 4% | SOLVAY |
| (as dispersant) | | |
| Ufoxan 3A | 2% | BORREGGARD |
| (as dispersant) | | |
| Breakthru 240S | 3% | EVONICK |
| (as wetting agent) | | |
| Sipernat 22S | 6% | EVONICK |
| (as carrier) | | |
| Kaolin | 85% | |

In summary, numerous phenyl-based compounds and thiazole based compounds were tested in various plant growth experiments, some of which showed increased herbicidal effect. Furthermore, some of the tested compounds showed selective herbicidal effect against weeds. Remarkably, these compounds can be readily applied as highly effective new agents designed to control both weeds growth and germination, and accordingly can protect crops against yield loss from weeds.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-25. (canceled)

26. A herbicidal composition comprising a compound represented by the Formula: 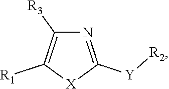
or an agriculturally acceptable salt thereof, wherein:
X is selected from N, S, and O;
R₁ and Y are each independently selected from the group consisting of: a nitro group, a hydroxy group, a carboxylic acid derivative, a halo group, a cyano group, a sulfinyl group, a sulfone group, a sulfonate group, a keto group, formyl, a haloalkyl group, —N(C₁-C₅), an azo group, O, P, N, NH, S, C, an optionally substituted C₄-C₂₀ cycloalkyl group, an optionally substituted C₅-C₂₀ heterocyclyl group, an optionally substituted aryl group, a heteroaryl group and any combination thereof;
R₂ is absent or is selected from hydrogen, an alkylhydroxy group, an alkoxy group, a thioalkoxy group, a thioalkyl group, an optionally substituted C₄-C₂₀ alkyl group, an optionally substituted C₄-C₂₀ cycloalkyl group, an optionally substituted C₄-C₂₀ bicyclic ring, an optionally substituted C₄-C₂₀ heterocyclyl group, an optionally substituted aryl group, an optionally substituted heteroaryl, and 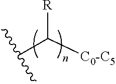
and any combination thereof;
each R is independently selected from an optionally substituted C₄-C₂₀ heterocyclyl, an optionally substituted C₄-C₂₀ cycloalkyl group, a mercapto group, an amino, a hydroxy group, a halo group, a cyano group, a nitro group, a carboxylic acid derivative, an optionally substituted C₁-C₁₀ alkyl group comprising a heteroatom, and any combination thereof;
n is 1, 2 or 3;
R₃ is absent or is selected from an alkyl group, an alkylhydroxy group, an alkoxy group, a halo group, a haloalkyl group, a nitro group, a hydroxy group, a sulfinyl group, a sulfone group, a sulfonate group and any combination thereof;
wherein when Y is a nitro group, a hydroxy group, a halo group, or a cyano group, R₂ is absent,
the herbicidal composition comprising said compound, an agriculturally acceptable salt of said compound or both.

27. The herbicidal composition of claim 26, wherein R₃ is absent or is selected from a C₁-C₅ alkyl group, an alkylhydroxy group, an alkoxy group, a halo group, a haloalkyl group, a nitro group, a hydroxy group, a sulfinyl group, a sulfone group, and a sulfonate group and any combination thereof.

28. The herbicidal composition of claim 26, wherein Y is NH, and R₂ is selected from hydrogen, an optionally substituted C₄-C₈ alkyl group, an optionally substituted C₄-C₆ heterocyclyl group, an optionally substituted C₄-C₆ cycloalkyl group, a C₆-C₁₂ heterocyclyl, and 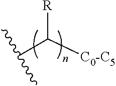
and any combination thereof.

29. The herbicidal composition of claim 26, represented by the Formula:

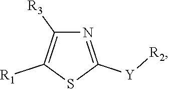

30. The herbicidal composition of claim 26, wherein said compound is represented by Formula IV: 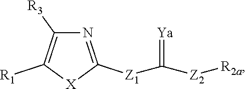
wherein:
Yₐ is selected from O, N, and S;
Z₁ is selected from O, NH and S;
Z₂ is selected from H, O, N and S, or is absent;
R₂ₐ is selected from a C₁-C₅ haloalkyl group, a C₅-C₁₀ cycloalkyl group, a C₅-C₁₀ alkyl group, —(CH₂)ₚ-T-(CH₂)ₒ, C₁-C₅ alkaryl optionally substituted by R₅, and 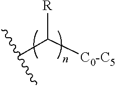
and any combination thereof,
wherein:
T is selected from O, S and N, p is 1, 2, 2 or 4, o is 1, 2, 3, 4 or 5, wherein when T is O and p is 1, o is selected from 1, 3, 4 and 5;
and R₅ is selected from a halo group, a C₁-C₅ alkyl group, an C₁-C₅ alkoxy group, a C₁-C₅ thioalkoxy group, a carboxylic acid derivative, a hydroxy group, a mercapto group, a sulfinyl group, a sulfone group, a sulfonate group, a cyano group, and an azo group.

31. The herbicidal composition of claim 30, wherein R₃ is selected from hydrogen, and a C₁-C₅ alkyl group.

32. The herbicidal composition of claim 30, wherein said compound is represented by Formula V: 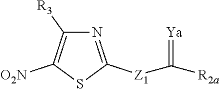
or by Formula VI: 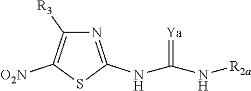
wherein:
Z₁ is selected from O and N;
and Yₐ is selected from O and S.

33. The herbicidal composition of claim 26, wherein said compound is represented by Formula III:

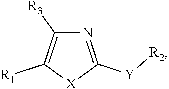

34. The herbicidal composition of claim 26, wherein R₁ is a nitro group, and Y is selected from hydrogen, an optionally substituted C₃-C₉ heterocyclyl group, an optionally substituted C₅-C₉ heteroaryl group, and an optionally substituted C₅-C₉ aryl group and any combination thereof.

35. The herbicidal composition of claim 26, wherein said compound is selected from the group consisting of:

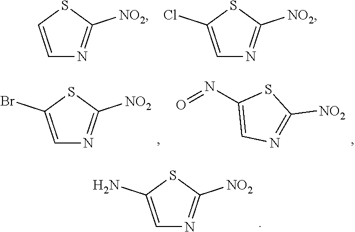

36. The herbicidal composition of claim 26, further comprising an agriculturally acceptable carrier.

37. A method for controlling plant growth, comprising contacting the plant, a part of the plant, a seed of the plant, or the area under cultivation with the herbicidal composition of claim 26.

38. The method of claim 37, wherein said plant is selected from a crop plant and a weed.

39. The method of claim 37, being for controlling growth of said weed.

40. The method of claim 37, wherein said contacting comprises applying an effective amount of the herbicidal composition to the plant, a part of the plant, a seed of the plant, or the area under cultivation.
